(19) United States
(12) Patent Application Publication
(10) Pub. No.: US 2014/0213370 A1
(43) Pub. Date: Jul. 31, 2014

(54) GAME SYSTEM, GAME DEVICE, GAME SYSTEM CONTROL METHOD, AND GAME SYSTEM CONTROL PROGRAM

(71) Applicant: Kazuya TAKAHASHI, Torrance, CA (US)

(72) Inventor: Kazuya TAKAHASHI, Torrance, CA (US)

(21) Appl. No.: 13/754,409

(22) Filed: Jan. 30, 2013

(51) Int. Cl. A63F 13/12; G06F 17/00

(52) U.S. Cl. CPC A63F 13/12; G06F 17/00
USPC 463/42; 700/92

(57) ABSTRACT

A game device may include, but is not limited to, a first distribution unit, a first control unit, and a first reduction unit. The first distribution unit may be configured to increase an individual amount of a first virtual value that is individually-owned and in-game-usable by an individual user of a first in-game group of users, with reference to the amount of a second virtual value that is commonly-associated to the first in-game group of users. The first control unit may be configured to decrease the individual amount of the first virtual value, in accordance with an in-game-use-request by the individual user. The first reduction unit may be configured to reduce at least a part of the individual amount of the first virtual value to increase the amount of the second virtual value.

### BACKGROUND OF THE INVENTION

1. Field of the Invention

The present invention relates to a game system, a game device, a game system control method, and a game system control program.

2. Description of the Related Art

Japanese Laid-open Patent Publication No. 2006-075508 discloses that when a game value is spent a game is executed, and in which, responsive to the game results, payment is issued, and a predetermined proportion of the spent play value is accumulated as a special bonus fund for paying the special bonus.

Japanese Laid-open Patent Publication No. 2008-183310 discloses that if the spending of a game value is a condition for executing a game, there is a game system in which, after demonstrating that a game medium (such as a token) having a physical form being virtually paid out, the game medium is collected and credit corresponding to the paid out amount of game medium is added to the player's credit.

### SUMMARY

In one embodiment, a game system may include, but is not limited to, a first storage unit, a second storage unit, a first distribution unit, a first control unit and a first reduction unit. The first storage unit may be configured to store a first information related to a first virtual value that is commonly-associated to a first in-game group of users. The second storage unit may be configured to store a second information related to a second virtual value that is individually-ownable and in-game-usable by an individual user of the first in-game group of users. The first distribution unit may be configured to increase an individual amount of the second virtual value individually-owned by the individual user of the first in-game group of users, with reference to the amount of the first virtual value. The first control unit may be configured to decrease the individual amount of the second virtual value individually-owned by the individual user of the first in-game group of users, in accordance with an in-game use request by the individual user. The first reduction unit may be configured to reduce at least a part of the individual amount of the second virtual value, individually-owned by the individual user of the first in-game group of users, and to increase the amount of the first virtual value.

In another embodiment, a game system may include, but is not limited to, an inter-group competition unit and a distribution unit. The inter-group competition unit may be configured to perform an inter-group competition between a first in-game group of users and a second in-game group of users under a competition rule, with reference to the amount of a first virtual value and the amount of a third virtual value. The amount of the first virtual value is variable depending upon a first totality of individual game-results of individual users of the first in-game group of users. The amount of the third virtual value is variable depending upon a second totality of individual game-results of individual users of the second in-game group of users. The distribution unit may be configured to perform, with reference to a result of the inter-group competition performed by the inter-group competition unit, at least one of a first way of virtual-value-distribution to virtual value amounts individually-owned by individual users of the first in-game group of users, and a second way of virtual-value-distribution to virtual value amounts individually-owned by individual users of the second in-game group of users.

In still another embodiment, a game device may include, but is not limited to, a first distribution unit, a first control unit, and a first reduction unit. The first distribution unit may be configured to increase an individual amount of a first virtual value that is individually-owned and in-game-usable by an individual user of a first in-game group of users, with reference to the amount of a second virtual value that is commonly-associated to the first in-game group of users. The first control unit may be configured to decrease the individual amount of the first virtual value, in accordance with an in-game-use-request by the individual user. The first reduction unit may be configured to reduce at least a part of the individual amount of the first virtual value to increase the amount of the second virtual value.

In yet another aspect of the invention, a gaming method may include, but is not limited to, i) increasing, by a computer, an individual amount of a first virtual value that is individually-owned and in-game-usable by an individual user of a first in-game group of users, with reference to the amount of a second virtual value that is commonly associated to the first in-game group of users; ii) decreasing, by the computer, the individual amount of the first virtual value, in accordance with an in-game-user request by the individual user; and iii) reducing, by the computer, at least a part of the individual amount of the first virtual value to increase the amount of the second virtual value.

In a further aspect of the invention, a gaming method may include, but is not limited to, i) performing, by a computer, an inter-group competition between a first in-game group of users and a second in-game group of users under a competition rule, with reference to the amount of a first virtual value and the amount of a second virtual value, the amount of the first virtual value being variable depending upon a first totality of individual game-results of individual users of the first in-game group of users, the amount of the second virtual value being variable depending upon a second totality of individual game-results of individual users of the second in-game group of users; and ii) performing, by the computer, with reference to a result of the inter-group competition, at least one of a first way of virtual-value-distribution to virtual value amounts individually-owned by individual users of the first in-game group of users, and a second way of virtual-value-distribution to virtual value amounts individually-owned by individual users of the second in-game group of users.

In an additional aspect of the invention, a computer program product embodied on a non-transitory computer readable medium may include, but is not limited to, i) instructions to increase an individual amount of a first virtual value that is individually-owned and in-game-usable by an individual user of a first in-game group of users, with reference to the amount of a second virtual value that is commonly-associated to the first in-game group of users; ii) instructions to decrease the individual amount of the first virtual value, in accordance with an in-game-use-request by the individual user; and iii) instructions to reduce at least a part of the individual amount of the first virtual value to increase the amount of the second virtual value.

In an additional aspect of the invention, a computer program product embodied on a non-transitory computer readable medium may include, but is not limited to, i) instructions to perform an inter-group competition between a first in-game group of users and a second in-game group of users under a competition rule, with reference to the amount of a first virtual value and the amount of a second virtual value, the amount of the first virtual value being variable depending upon a first totality of individual game-results of individual users of the first in-game group of users, the amount of the second virtual value being variable depending upon a second totality of individual game-results of individual users of the second in-game group of users; and ii) instructions to perform, with reference to a result of the inter-group competition, at least one of a first way of virtual-value-distribution to virtual value amounts individually-owned by individual users of the first in-game group of users, and a second way of virtual-value-distribution to virtual value amounts individually-owned by individual users of the second in-game group of users.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a view showing an example of the overall configuration of a game system according to one or more embodiments of the present invention;

FIG. 2 is a schematic view of operations performed between groups and operations within a group in the game system of the embodiments;

FIG. 3 is a schematic view of a plurality of stages in a separate game according to one or more embodiments of the present invention;

FIG. 4 is a view showing an example of functional configurations of a user terminal according to one or more embodiments of the present invention;

FIG. 5 is a view showing an example of a screen displayed by a display unit at the start of a separate game according to one or more embodiments of the present invention;

FIG. 6 is a view showing an example of a screen that is displayed when the Start Game button in the screen shown in FIG. 5 is operated according to one or more embodiments of the present invention;

FIG. 7 is a view showing an example of a screen display when the Next button on the screen displayed in FIG. 6 is operated according to one or more embodiments of the present invention;

FIG. 8 is a view showing an example of functional configurations of an SNS server according to one or more embodiments of the present invention;

FIG. 9 is a view showing an example of user-related information stored in a user-related information storage unit according to one or more embodiments of the present invention;

FIG. 10 is a view showing an example of functional configurations of the game server according to one or more embodiments of the present invention;

FIG. 11 is a view showing an example of user-related information stored in a user-related information storage unit according to one or more embodiments of the present invention;

FIG. 12 is a view showing an example of a usual payout table in a separate game according to one or more embodiments of the present invention;

FIG. 13 is a view showing an example of a payout table that has been changed to be to the advantage of a user according to one or more embodiments of the present invention;

FIG. 14 is a view showing an example of a usual symbol table in a separate game according to one or more embodiments of the present invention;

FIG. 15 is a view showing an example of a table with symbols changed to the advantage of the user involved in a separate game according to one or more embodiments of the present invention;

FIG. 16 is a schematic view of conditions in which effective lines are to be added in a separate game according to one or more embodiments of the present invention;

FIG. 17 is a schematic view showing an example of a play screen of a slot machine game as a separate game when the mode or form of the slot machine game is changed according to one or more embodiments of the present invention;

FIG. 18 is a schematic view showing an example of a screen that shows a user progress through stages of other users within the groups according to one or more embodiments of the present invention;

FIG. 19 is a schematic view showing an example of a relationship of correspondence between the ratio of virtual money owned by king (1) and the distributed amount according to one or more embodiments of the present invention;

FIG. 20 is a schematic view showing an example of a relationship of correspondence between the ratio of the virtual money owned by king (1) and a threshold value according to one or more embodiments of the present invention;

FIG. 21 is a schematic view showing an example of the relationship of correspondence between the ranking of the virtual money owned by king (1) and the distributed amount according to one or more embodiments of the present invention;

FIG. 22 is a schematic view showing an example of a display screen displaying the results of inter-group competition for a case of two registered groups according to one or more embodiments of the present invention;

FIG. 23 is a schematic view showing an example of a display screen displaying the results of inter-group competition for a case in which there are three or more registered groups according to one or more embodiments of the present invention;

FIG. 24 is a flowchart showing the flow of processes executed by a control unit included in a game system according to one or more embodiments of the present invention;

FIG. 25 is a flowchart showing the flow of processes executed by a control unit included in a game system according to one or more embodiments of the present invention;

FIG. 26 is a flowchart showing the flow of processes executed by a control unit included in a game system according to one or more embodiments of the present invention;

FIG. 27 is a flowchart showing the flow of processes executed by a control unit included in a game system according to one or more embodiments of the present invention;

FIG. 28 is a flowchart showing the flow of processes executed by a control unit included in a game system according to one or more embodiments of the present invention;

FIG. 29 is a flowchart showing the flow of processes executed by a control unit included in a game system according to one or more embodiments of the present invention;

FIG. 30 is a flowchart showing the flow of processes executed by a control unit included in a game system according to one or more embodiments of the present invention;

FIG. 31 is a flowchart showing the flow of processes executed by a control unit included in a game system according to one or more embodiments of the present invention;

FIG. 32 is a flowchart showing the flow of processes executed by a control unit included in a game system according to one or more embodiments of the present invention;

FIG. 33 is a flowchart showing the flow of processes executed by a control unit included in a game system according to one or more embodiments of the present invention; and

FIG. 34 is a view showing another example of functional configurations of the game system according to one or more embodiments of the present invention.

### DETAILED DESCRIPTION OF THE PREFERRED EMBODIMENTS

Embodiments of the invention will be now described herein with reference to illustrative embodiments. Those skilled in the art will recognize that many alternative embodiments can be accomplished using the teaching of the embodiments of the present invention and that the invention is not limited to the embodiments illustrated for explanatory purpose.

The term “configured” is used to describe a component, section or part of a device includes hardware and/or software that is constructed and/or programmed to carry out the desired function.

The embodiments of methods, software, firmware or codes described above may be implemented by instructions or codes stored on a machine-accessible or machine readable medium. The instructions or codes are executable by a processing element or processing unit. The machine-accessible/readable medium may include, but is not limited to, any mechanisms that provide, store and/or transmit information in a form readable by a machine, such as a computer or electronic system. In some cases, the machine-accessible/readable medium may include, but is not limited to, random-access memories (RAMs), such as static RAM (SRAM) or dynamic RAM (DRAM), read-only memory (ROM), magnetic or optical storage medium and flash memory devices. In other cases, the machine-accessible/readable medium may include, but is not limited to, any mechanism that receives, copies, stores, transmits, or otherwise manipulates electrical, optical, acoustical or other form of propagated signals such as carrier waves, infrared signals, digital signals, including the embodiments of methods, software, firmware or code set forth above.

Furthermore, the particular features, structures, or characteristics may be combined in any suitable manner in one or more embodiments.

It is apparent that the present invention is not limited to the above embodiments, but may be modified and changed without departing from the scope and spirit of the invention.

In one aspect of the invention, a game system may include, but is not limited to, a first storage unit, a second storage unit, a first distribution unit, a first control unit and a first reduction unit. The first storage unit may be configured to store a first information related to a first virtual value that is commonly-associated to a first in-game group of users. The second storage unit may be configured to store a second information related to a second virtual value that is individually-ownable and in-game-usable by an individual user of the first in-game group of users. The first distribution unit may be configured to increase an individual amount of the second virtual value individually-owned by the individual user of the first in-game group of users, with reference to the amount of the first virtual value. The first control unit may be configured to decrease the individual amount of the second virtual value individually-owned by the individual user of the first in-game group of users, in accordance with an in-game use request by the individual user. The first reduction unit may be configured to reduce at least a part of the individual amount of the second virtual value, individually-owned by the individual user of the first in-game group of users, and to increase the amount of the first virtual value.

The first virtual value is commonly-associated to the first in-game group of users. In some cases, the first in-game group of users may not be given any right to deal with the first virtual value by his or her own mind. In that case, the first virtual value is not ownable by the first in-game group of users. The first virtual value may influence advantages or disadvantages in game to the first in-game group of users. The first virtual value is not different among different users belonging to the first in-game group. Each user belonging to the first in-game group is associated to the common value, the first value.

The second virtual value is individually-ownable and in-game-usable by an individual user belonging to the first in-game group of users. At least an individual user is given a right to own its own amount of the second virtual value. In some cases, different individual users belonging to the first in-game group of users may own different amounts of the second virtual value. In other cases, an individual user belonging to the first in-game group of users may own the second virtual value, and another individual user belonging to the first in-game group of users may own other virtual value than the second virtual value.

In some cases, the individual user belonging to the first in-game group have a right to own the individual amount of the second virtual value, and the first distribution unit is configured to increase that individual amount, with reference to the amount of the first virtual value. In some cases, the amount of increase of the individual amount of the second virtual value may depend simply on the amount of the first virtual value. In other cases, the amount of increase of the individual amount of the second virtual value may be determined by the first distribution unit by taking into account at least the amount of the first virtual value, but optionally in combination with other factors. If different individual users belonging to the first in-game group of users own different amounts of the second virtual value, the first distribution unit may increase different amounts of the second virtual value, by taking into account at least the amount of the first virtual value. If an individual user belonging to the first in-game group of users owns the second virtual value, and another individual user belonging to the first in-game group of users owns other virtual value than the second virtual value, then the first distribution unit may increase at least the amount of increase of the individual amount of the second virtual value of the individual user. In this case, the first distribution unit may be configured to also increase a particular amount of other virtual value than the second virtual value owned by the other individual user, with reference to the amount of the first virtual value, or by taking into account at least the amount of the first virtual value, or otherwise configured not to do anything for changing the particular amount of other virtual value.

For game progression, mostly an individual user belonging to the first in-game group is given a right to make the in-game use request to use or consume the individual amount of the second virtual value individually-owned by that individual user. The first control unit may decrease the individual amount of the second virtual value individually-owned by the individual user, in accordance with the in-game use request made by the individual user.

The first reduction unit reduces at least a part of the individual amount of the second virtual value, individually-owned by the individual user of the first in-game group of users, and increases the amount of the first virtual value, where the amount of increasing the first virtual value may depend upon or be independent from the amount of reducing the individual amount of the second virtual value. In the former case, the amount of increasing the first virtual value and the amount of reducing the individual amount of the second virtual value may be determined under a predetermined rule or a changeable rule. In some case, the first reduction unit may be configured to, for example, transform at least a part of the individual amount of the second virtual value to the first virtual value. For example, the first reduction unit may be configured to return at least a part of the individual amount of the second virtual value from the individual user of the first in-game group of users to the first virtual value commonly-associated to a first in-game group of users. The second virtual value may include, but is not limited to, virtual items or virtual money.

In some embodiments, the first control unit may be configured to further perform processes of a game that is playable by the individual user of the first in-game group of users, while decreasing the individual amount of the second virtual value individually-owned by the individual user, in accordance with the in-game-use-request by the individual user. The first control unit may be configured to increase the individual amount of the second virtual value individually-owned by the individual user, with reference to a result of the processes of the game.

For game progression, mostly an individual user belonging to the first in-game group is given a right to make the in-game use request to use or consume the individual amount of the second virtual value individually-owned by that individual user. In this case, the first control unit may further perform processes of a game played by the individual user of the first in-game while decreasing the individual amount of the second virtual value individually-owned by the individual user, in accordance with the in-game use request made by the individual user.

In some embodiments, the game is playable in sole by an individual user of the first in-game group of users. In other embodiments, the game is playable together or with interactions among individual users of the first in-game group of users.

In some embodiments, the first control unit may be configured to make a change in mode of the game if the first control unit verified that a condition for progression of the game is satisfied. A game mode may be a distinct configuration which effects how the game behaves distinctively and/or a distinct form of expressions or display which effects how the game is expressed or displayed on a screen. A game with several modes will present different settings in each one, changing how a particular element of the game is played and/or displayed. A game in different game modes will behave distinctively in a particular element of the game and/or in a particular expression or display of the game. In a case of a slot machine game, the first control unit may be configured to change the slot machine game, for example but not limited to, from one with three columns into one with five columns.

In some embodiments, the first distribution unit may be configured to distribute at least a part of the amount of the first virtual value to the individual amount of the second virtual value individually-owned by the individual user, in accordance with the amount of the first virtual value.

There is no need to restrict the rule of distribution. In some cases, the distribution may be a uniform distribution to individual amounts of the second virtual value individually-owned by individual users belonging to the first in-game group. In other cases, the distribution may be a performance-based distribution under a predetermined or changeable rule. In other embodiments, the first distribution unit may be configured to increase the individual amount of the second virtual value individually-owned by the individual user, without distributing at least a part of the amount of the first virtual value to the individual amount.

In some embodiments, the game system may include, but is not limited to, a third storage unit, a fourth storage unit, a second distribution unit, a second control unit, a second reduction unit and a competition unit, in addition to the first storage unit, the second storage unit, the first distribution unit, the first control unit and the first reduction unit. The third storage unit may be configured to store a third information related to a third virtual value that is commonly-associated to a second in-game group of users. The fourth storage unit may be configured to store a fourth information related to a fourth virtual value that is individually-ownable and in-game-usable by an individual user of the second in-game group of users. The second distribution unit may be configured to increase an individual amount of the fourth virtual value individually-owned by the individual user of the second in-game group of users, with reference to the amount of the third virtual value. The second control unit may be configured to decrease the individual amount of the fourth virtual value individually-owned by the individual user of the second in-game group of users, in accordance with an in-game-use-request by the individual user of the second in-game group of users. The second reduction unit may be configured to reduce at least a part of the individual amount of the fourth virtual value, individually-owned by the individual user of the second in-game group of users, to increase the amount of the first virtual value. The competition unit may be configured to perform a competition between the first in-game group of users and the second in-game group of users under a competition rule, with reference to the amount of the first virtual value and the amount of the third virtual value.

The third storage unit, the fourth storage unit, the second distribution unit, the second control unit, the second reduction unit may typically be configured in substantially the same manner as those of the first storage unit, the second storage unit, the first distribution unit, the first control unit and the first reduction unit, respectively. The competition is performed under a competition rule, by taking into account at least the amount of the first virtual value and the amount of the third virtual value with or without any other factors. There is no need to limit the competition rule which may be pre-fixed or may be changeable. Any rule can be set as the competition rule provided that the competition is made by taking into account at least the amount of the first virtual value and the amount of the third virtual value.

In some cases, the first distribution unit may be configured to decide an increasing amount of the individual amount of the second virtual value, with reference to the amount of the first virtual value and the amount of the third virtual value. In this case, the first distribution unit may be configured to decide the increasing amount of the individual amount of the second virtual value, depending on a result of comparison made in accordance with a rule of comparison between the amount of the first virtual value and the amount of the third virtual value.

In other cases, the first distribution unit may be configured to decide the frequency of increment in the individual amount of the second virtual value, depending on a result of comparison made in accordance with a rule of comparison between the amount of the first virtual value and the amount of the third virtual value.

In still other cases, the first distribution unit is configured to decide the amount of one-time-increment in the individual amount of the second virtual value, depending on a result of comparison made in accordance with a rule of comparison between the amount of the first virtual value and the amount of the third virtual value.

In another aspect of the invention, a game system may include, but is not limited to, an inter-group competition unit and a distribution unit. The inter-group competition unit may be configured to perform an inter-group competition between a first in-game group of users and a second in-game group of users under a competition rule, with reference to the amount of a first virtual value and the amount of a third virtual value. The amount of the first virtual value is variable depending upon a first totality of individual game-results of individual users of the first in-game group of users. The amount of the third virtual value is variable depending upon a second totality of individual game-results of individual users of the second in-game group of users. The distribution unit may be configured to perform, with reference to a result of the inter-group competition performed by the inter-group competition unit, at least one of a first way of virtual-value-distribution to virtual value amounts individually-owned by individual users of the first in-game group of users, and a second way of virtual-value-distribution to virtual value amounts individually-owned by individual users of the second in-game group of users.

The competition is performed under a competition rule, by taking into account at least the amount of the first virtual value and the amount of the third virtual value with or without any other factors. There is no need to limit the competition rule which may be pre-fixed or may be changeable. Any rule can be set as the competition rule provided that the competition is made by taking into account at least the amount of the first virtual value and the amount of the third virtual value. There is no need to limit the first way of virtual-value-distribution. Any way can be set as the first way of virtual-value-distribution provided that the first way of virtual-value-distribution is made by taking into account at least a result of the inter-group competition performed by the inter-group competition unit. Not only the result of the inter-group competition but also any other factors can be taken into account to set the first way of virtual-value-distribution. Also, there is no need to limit the second way of virtual-value-distribution. Any way can be set as the second way of virtual-value-distribution provided that the second way of virtual-value-distribution is made by taking into account at least a result of the inter-group competition performed by the inter-group competition unit. Not only the result of the inter-group competition but also any other factors can be taken into account to set the second way of virtual-value-distribution.

In still another aspect of the invention, a game device may include, but is not limited to, a first distribution unit, a first control unit, and a first reduction unit. The first distribution unit may be configured to increase an individual amount of a first virtual value that is individually-owned and in-game-usable by an individual user of a first in-game group of users, with reference to the amount of a second virtual value that is commonly-associated to the first in-game group of users. The first control unit may be configured to decrease the individual amount of the first virtual value, in accordance with an in-game-use-request by the individual user. The first reduction unit may be configured to reduce at least a part of the individual amount of the first virtual value to increase the amount of the second virtual value.

The first virtual value is individually-ownable and in-game-usable by an individual user belonging to the first in-game group of users. At least an individual user is given a right to own its own amount of the first virtual value. In some cases, different individual users belonging to the first in-game group of users may own different amounts of the first virtual value. In other cases, an individual user belonging to the first in-game group of users may own the first virtual value, and another individual user belonging to the first in-game group of users may own other virtual value than the first virtual value.

The second virtual value is commonly-associated to the first in-game group of users. In some cases, the first in-game group of users may not be given any right to deal with the second virtual value by his or her own mind. In that case, the second virtual value is not ownable by the first in-game group of users. The second virtual value may influence advantages or disadvantages in game to the first in-game group of users. The second virtual value is not different among different users belonging to the first in-game group. Each user belonging to the first in-game group is associated to the common value, the second value.

In some cases, the individual user belonging to the first in-game group have a right to own the individual amount of the first virtual value, and the first distribution unit is configured to increase that individual amount, with reference to the amount of the second virtual value. In some cases, the amount of increase of the individual amount of the first virtual value may depend simply on the amount of the second virtual value. In other cases, the amount of increase of the individual amount of the first virtual value may be determined by the first distribution unit by taking into account at least the amount of the second virtual value, but optionally in combination with other factors. If different individual users belonging to the first in-game group of users own different amounts of the first virtual value, the first distribution unit may increase different amounts of the first virtual value, by taking into account at least the amount of the second virtual value. If an individual user belonging to the first in-game group of users owns the first virtual value, and another individual user belonging to the first in-game group of users owns other virtual value than the first virtual value, then the first distribution unit may increase at least the amount of increase of the individual amount of the first virtual value of the individual user. In this case, the first distribution unit may be configured to also increase a particular amount of other virtual value than the first virtual value owned by the other individual user, with reference to the amount of the second virtual value, or by taking into account at least the amount of the second virtual value, or otherwise configured not to do anything for changing the particular amount of other virtual value.

For game progression, mostly an individual user belonging to the first in-game group is given a right to make the in-game use request to use or consume the individual amount of the first virtual value individually-owned by that individual user. The first control unit may decrease the individual amount of the first virtual value individually-owned by the individual user, in accordance with the in-game use request made by the individual user.

The first reduction unit reduces at least a part of the individual amount of the first virtual value, individually-owned by the individual user of the first in-game group of users, and increases the amount of the second virtual value, where the amount of increasing the second virtual value may depend upon or be independent from the amount of reducing the individual amount of the first virtual value. In the former case, the amount of increasing the second virtual value and the amount of reducing the individual amount of the first virtual value may be determined under a predetermined rule or a changeable rule. In some case, the first reduction unit may be configured to, for example, transform at least a part of the individual amount of the first virtual value to the second virtual value. For example, the first reduction unit may be configured to return at least a part of the individual amount of the first virtual value from the individual user of the first in-game group of users to the second virtual value commonly-associated to a first in-game group of users. The first virtual value may include, but is not limited to, virtual items or virtual money.

In yet another aspect of the invention, a gaming method may include, but is not limited to, i) increasing, by a computer, an individual amount of a first virtual value that is individually-owned and in-game-usable by an individual user of a first in-game group of users, with reference to the amount of a second virtual value that is commonly associated to the first in-game group of users; ii) decreasing, by the computer, the individual amount of the first virtual value, in accordance with an in-game-user request by the individual user; and iii) reducing, by the computer, at least a part of the individual amount of the first virtual value to increase the amount of the second virtual value.

In a further aspect of the invention, a gaming method may include, but is not limited to, i) performing, by a computer, an inter-group competition between a first in-game group of users and a second in-game group of users under a competition rule, with reference to the amount of a first virtual value and the amount of a second virtual value, the amount of the first virtual value being variable depending upon a first totality of individual game-results of individual users of the first in-game group of users, the amount of the second virtual value being variable depending upon a second totality of individual game-results of individual users of the second in-game group of users; and ii) performing, by the computer, with reference to a result of the inter-group competition, at least one of a first way of virtual-value-distribution to virtual value amounts individually-owned by individual users of the first in-game group of users, and a second way of virtual-value-distribution to virtual value amounts individually-owned by individual users of the second in-game group of users.

In an additional aspect of the invention, a computer program product embodied on a non-transitory computer readable medium may include, but is not limited to, i) instructions to increase an individual amount of a first virtual value that is individually-owned and in-game-usable by an individual user of a first in-game group of users, with reference to the amount of a second virtual value that is commonly-associated to the first in-game group of users; ii) instructions to decrease the individual amount of the first virtual value, in accordance with an in-game-use-request by the individual user; and iii) instructions to reduce at least a part of the individual amount of the first virtual value to increase the amount of the second virtual value.

In an additional aspect of the invention, a computer program product embodied on a non-transitory computer readable medium may include, but is not limited to, i) instructions to perform an inter-group competition between a first in-game group of users and a second in-game group of users under a competition rule, with reference to the amount of a first virtual value and the amount of a second virtual value, the amount of the first virtual value being variable depending upon a first totality of individual game-results of individual users of the first in-game group of users, the amount of the second virtual value being variable depending upon a second totality of individual game-results of individual users of the second in-game group of users; and ii) instructions to perform, with reference to a result of the inter-group competition, at least one of a first way of virtual-value-distribution to virtual value amounts individually-owned by individual users of the first in-game group of users, and a second way of virtual-value-distribution to virtual value amounts individually-owned by individual users of the second in-game group of users.

### [Overall Configuration]

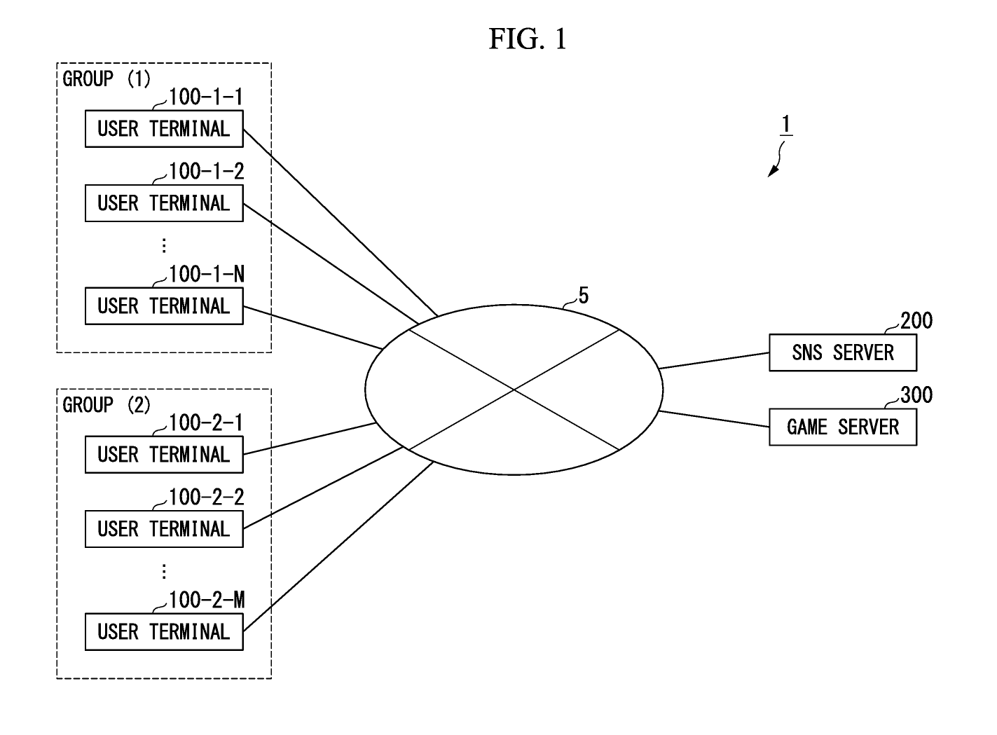

FIG. 1 shows an example of the overall configuration of a game system 1 according to an embodiment of the present invention. The game system 1 may include, but is but limited to, for example, a plurality of user terminals 100-1-1, 100-1-2, . . . , 100-1-N (where N is a positive integer), a plurality of user terminals 100-2-1, 100-2-2, . . . , 100-2-M (where M is a positive integer), an SNS (social networking service) server 200, and a game server (game device) 300.

Because each of the user terminals may have the same configuration, in the following description, if no distinction is made as to which user terminal is being referred to, the notation “user terminal 100” will be used. The user terminal 100 may be any available device, such as, a mobile telephone (including a smart phone), a tablet terminal, a personal computer, a portable information terminal, or a dedicated game console or the like. Each of a user group that uses the user terminals 100-1-1, 100-1-2, . . . , 100-1-N and a user group that uses the user terminals 100-2-1, 100-2-2, . . . , 100-2-M is constituted by users that form groups within the game. In the following, the group of users using the user terminals 100-1-1 100-1-2, . . . , 100-1-N will be referred to as a group 1, and the group of users using the user terminals 100-2-1, 100-2-2, . . . , 100-2-M will be referred to as a group 2. The association of users with groups is done in either the SNS server 200, the game server 300, or both.

The game system 1 may include an arbitrary number of user terminals 100. The game system 1 may include the user terminals 100 that are used by three or more groups of users.

The user terminal 100, the SNS server 200, and the game server 300 are connected via a network 5. The network 5 may be an information communication network, for example, a cellular phone network, a PHS (Personal Handy-phone System) network, a VPN (virtual private network), a dedicated communication network, a WAN (wide area network), an LAN (local area network), a PSTN (public switched telephone network), or the like, or a combination thereof.

### [Overall of the Game]

The game provided by the game system 1 to a user of the user terminal 100 will now be generally described. The game provided by the game system 1 provides an inter-group competition mode in which groups compete for the virtual money owned by the king, who is the virtual leader of a group, and another mode in which each of the users belonging to that group plays an “separate game.” At a predetermined timing, the virtual money owned by the king is distributed as virtual fighting fund that is added to the virtual money owned by the users who are members of the corresponding group. A user can, based on the user's virtual money (fighting virtual money), play a separate game, and a part or all of the user's virtual money, which increases and decreased based on the playing result, is returned to the king. The king is a non-player character (NPC), the actions of which are controlled, for example, by the CPU (central processing unit) of the game serve 300 or the like.

In this case, the “virtual money” is one example of virtual values (virtual assets) usable within the game. The virtual money may be in units of actually existing currencies such as yen or dollars, or may alternatively be in units of a virtual currency. Other examples of virtual value may include in-game virtual gold coins, in-game virtual tokens, in-game items such as virtual weapons, virtual protective gear, and virtual keys, and player level, and the game system 1 may use diverse types of virtual value.

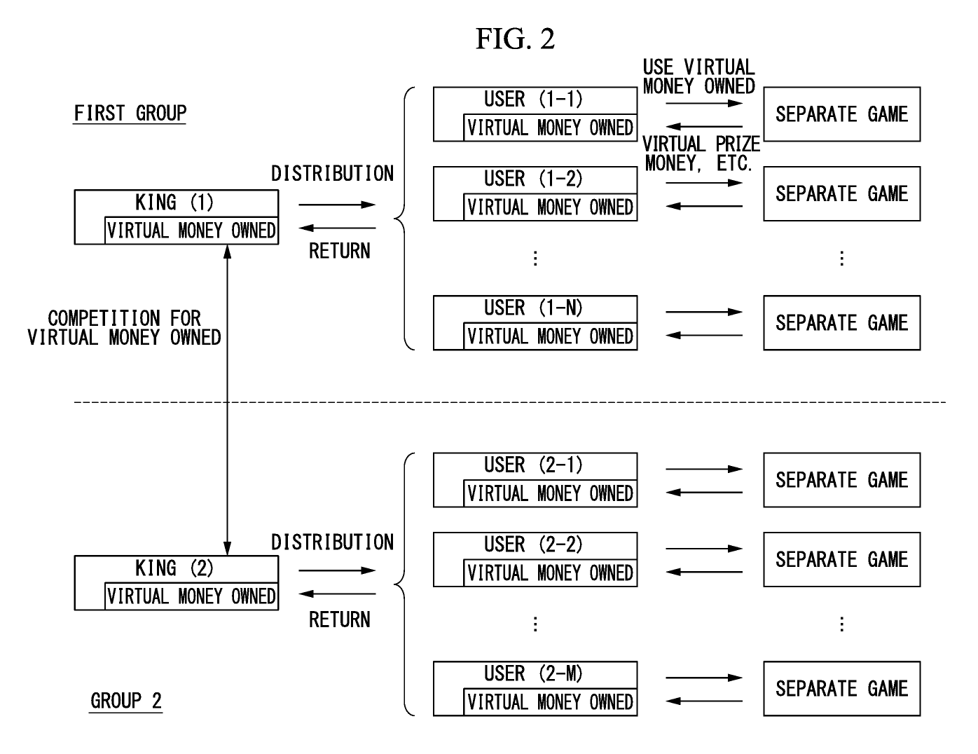

FIG. 2 is a schematic representation of operations performed between groups and within a group in the game system 1 of the present embodiment. As shown in FIG. 2, king (1) of group 1 distributes a part or all of his virtual money to the users (1-1), (1-2), . . . , (1-N) who belong to group 1. The users (1-1), (1-2), . . . , (1-N) correspond to the user terminals 100-1-1, 100-1-2, . . . , 100-1-N. The users (1-1), (1-2), . . . , (1-N) belonging to group 1, use the virtual money they own in separate games, and increase or decrease the virtual money they own by, for example, obtaining virtual prize money for the separate game. The users (1-1), (1-2), . . . , (1-N) belonging to group 1 return a part or all of the virtual money they own to king (1). Returning a part or all of the virtual money they own to king is a reduction of virtual money. In the same manner, king (2) of group 2 distributes a part or all of his virtual money to the users (2-1), (2-2), . . . , (2-M) who belong to group 2. The users (2-1), (2-2), . . . , (2-M) correspond to the user terminals 100-2-1, 100-2-2, . . . , 100-2-M. The users (2-1), (2-2), . . . , (2-M) belonging to group 2, use the virtual money they own in separate games, and increase or decrease the virtual money they own by, for example, obtaining virtual prize money for the separate game. The users (2-1), (2-2), . . . , (2-M) belonging to group 2 return a part or all of the virtual money they own to king (2).

At a predetermined timing, an inter-group competition is held for the virtual money of king (1) and king (2). This is the same even if three or more groups are registered in the game server 300 or the like, in which case the inter-group competition is done by announcing the ranking of virtual money owned by the kings for the three or more groups. Although there may be cases in which the types of currencies used between groups differ, or in which there is distribution or return of virtual value other than currency, in such cases a comparison is done after adjusting to comparable virtual values, based on, for example, currency exchange rates or redemption rates between the currency and items.

The separate games provided by the game system 1 may be typically, but not limited to, slot machine games that a user can play alone, and the use of owned virtual money includes betting virtual money they owned in a slot machine game. In a slot machine game, when the users positions predetermined symbols on an effective line (to be described later), an amount is added to the users owned virtual money as a payout. Also, in a slot machine game, the purchase of an item to increase the chance of a jackpot, or use thereof to change characters that are displayed on the slot machine game screen is also “use of owned virtual money.” In the case of something other than virtual value, such as an item, it could happen that a user borrows an in-game item from the king, increases the number of in-game items within the separate game, and then returns it to the king. Returning an in-game item to the king is considered to be a sort of reduction of virtual value.

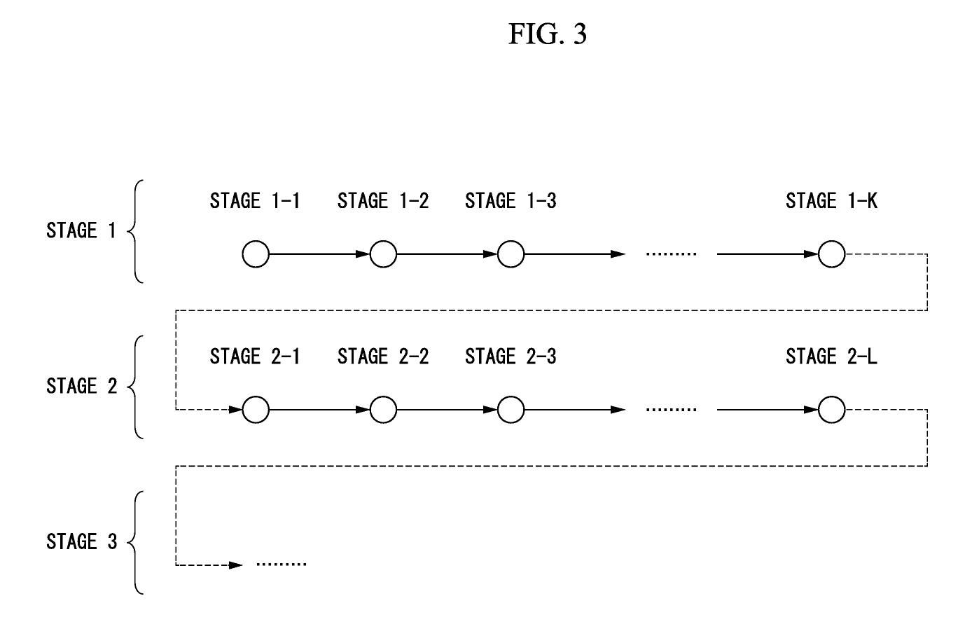

The separate game provided by the game system 1 is provided to a user in a form in which the user clears a plurality of stages. FIG. 3 is a schematic representation of a plurality of stages in a separate game. In the overall scheme, a user playing a separate game plays through the stages, for example, in the sequences of increasing numbers, such as stage 1, stage 2, and then stage 3. Each stage further has sub-stages. The stage 1 is completed when all of sub-stage 1-1, sub-stage 1-2, sub-stage 1-3, . . . , sub-stage 1-K (where K is a positive integer) have been cleared. In the same manner, the stage 2 is completed when all of sub-stage 2-1, sub-stage 2-2, sub-stage 2-3, . . . , sub-stage 2-K (where L is a positive integer) have been cleared. Each of the sub-stages is played out so that the user experiences a story, such as entering a mountain or cave to get items, knock down an enemy, or rescue someone. The clearing of each sub-stage is verified by the satisfying of a clearing condition individually set for each sub-stage. In a slot machine game, the clearing of a sub-stage is, for example, verified by the arrangement of all of a pre-established plurality of symbols on a line established in the horizontal direction or inclined direction. When sub-stages and stages are cleared, the virtual money owned by the corresponding user is increased as clearing bonus, or an item giving an advantage in a slot machine game is given to the user.

The separate game, rather than being based on a slot machine game, may be based on a card game, an action game, a puzzle game, a dice game, sugoroku, or another arbitrary game. The separate game is not restricted to a game that the user can play alone, and may alternatively be a game played by a plurality of users, such as a game played against an opponent. Additionally, the separate game is not restricted to a game which the user continues to operate, and can alternatively be a game in which the user sets a parameter and the game progresses automatically.

### [Configuration of the User Terminal 100 and the SNS Server 200]

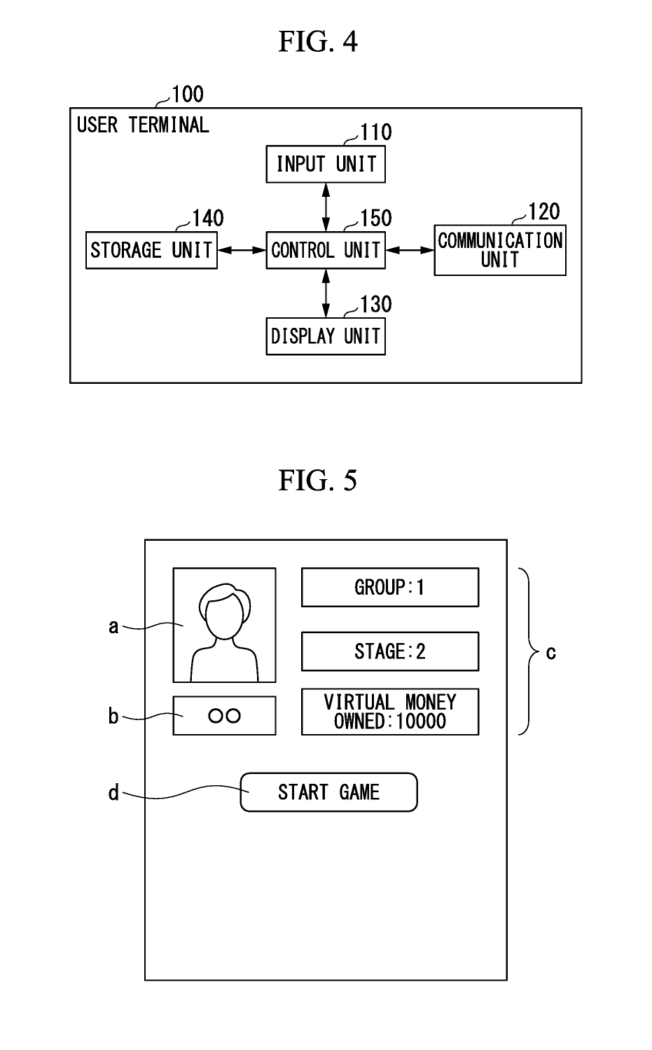

FIG. 4 shows an example of the functional configuration of the user terminal 100. The user terminal 100 may include, for example, but is not limited to, an input unit 110, a communication unit 120, a display unit 130, a storage unit 140, and a control unit 150.

The input unit 110 may include, for example, but is not limited to, an input device such as a button or a touch panel, and receives input of instruction information from a user. The input unit 110 may include, but is not limited to, a microphone that accepts an input of instruction information from a user as speech. The communication unit 120 may be configured to communicate with another computer connected via the network 5. The display unit 130 may, for example, be an LCD (liquid crystal display) or an organic EL (electroluminescence) display apparatus, and may be configured to display images, text, and the like. The input unit 110 and the display unit 130 may be integrated into a touch panel that accepts operations from a user. The storage unit 140 may be configured to store a non-illustrated OS (operating system), along with program such as browser applications and other information. The control unit 150 may be configured to execute processing in response to instruction information from a user input to the input unit 110. The control unit 150 may have a function as a control center of the user terminal 100 so as to control various parts of the user terminal 100. The control unit 150 may also have a function to display on the display unit 130, for example, via the operating system, a webpage and the like received from the game server 300 via the SNS server 200. The control unit 150 may be configured to allow progression of the game of the present system by communicating with the game server 300 via the SNS server 200.

The game of the present system may, for example, be, but is not limited to, a social game operating on an SNS, with the control unit 150 allowing progression of the game by operating a browser application. The expression “a social game operating on an SNS” means a game that is provided to members of the SNS, and that progresses with a connection maintained between users in the game. The expression “a connection maintained between users in the game” means, for example, “while users communicate with one another.”

FIG. 5 to FIG. 7 show examples of play screens of a separate game displayed by the display unit 130. FIG. 5 shows an example of a screen displayed by the display unit 130 at the start of the separate game. In FIG. 5, an image that shows the user, for example, as an avatar image or the like in an SNS, displayed in the region a. The user name is displayed in the region b. Various parameters of the user are displayed in the region c. A button (Start Game button) that accepts a game start instruction from the user is displayed in the region d.

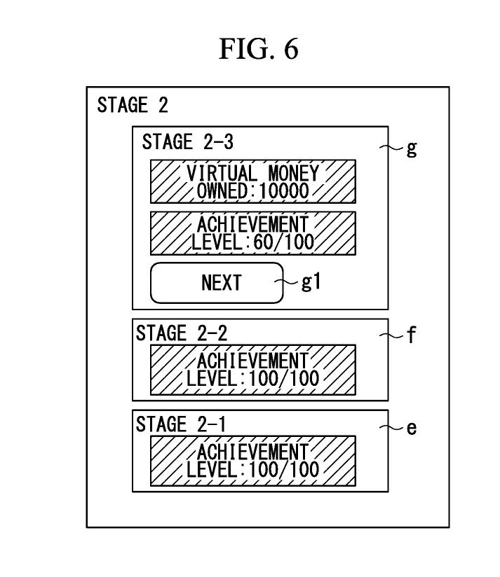

FIG. 6 shows an example of the screen that is displayed when the Start Game button in the screen shown in FIG. 5 is operated. As described above, a separate game is provided in a form in which a plurality of stages is cleared. FIG. 6 illustrates a progression screen that shows in region e that the stage 2-1 has been cleared, shows in the region f that the stage 2-2 has been cleared, and shows in the region g that the stage 2-3 has not yet been cleared. The region g that shows information regarding the stage 2-3 in which the user is about to play, in addition to showing the user's virtual money and the level of achievement in the stage 2-3, displays a “Next” button in the region g1 that accepts an instruction to start playing the stage 2-3.

The stage level of achievement (level of achieving the stage clearing condition) starts, for example, from zero, and varies depending upon the user's game results. The stage clearing condition may be, for example, but is not limited to, the arrangement by the user of specific symbols of one or a plurality of types a predetermined number of times in a slot machine game. In this case, the stage level of achievement increases in accordance with the number of times the user has arranged the specific symbols in the slot machine game. The stage clearing condition may be the amount of virtual money obtained by or the amount of virtual money owned by the user reaching a predetermined amount. In this case, the stage level of achievement increases or decreases in accordance with the amount of virtual money obtained by or owned by the user. The stage clearing condition is not limited to the above, and may be an arbitrarily set of conditions.

When the level of achievement of a stage reaches 100, that stage is cleared, enabling play in a new stage. To play a slot machine game, it is necessary for the virtual money owned by a user to be the minimum bet amount. The user's virtual money, in addition to distribution from the group king, increases in accordance with the slot machine game results, or is restored (increased) by the elapse of time.

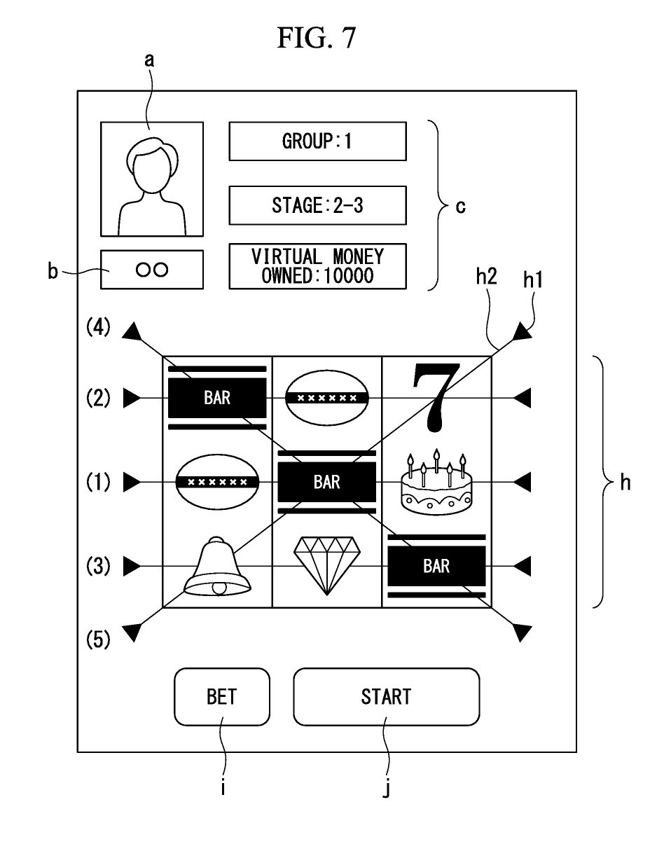

FIG. 7 shows an example of the screen display when the Next button on the screen displayed in FIG. 6 is operated. In FIG. 7, a virtual reel unit of the slot machine game is displayed in the region h. The region i displays a Bet button that accepts an instruction for the bet value (amount betted) by the user. The region j displays a Start Game button for accepting a start instruction by the user to start spinning the reel unit. When the user operates the Bet button, the required bet amount is subtracted from the owned virtual money and the bet value is increased. If the user operates the Start Game button in the condition in which the amount bet is at least the minimum amount, each column in the virtual reel unit starts to spin. After starting to spin, when a certain amount of time has elapsed, the reel unit automatically stops.

In FIG. 7, the numerals in parentheses indicate the effective lines in the slot machine game. The term “effective line” means that if the same symbol is arranged along the line, a payout in accordance with that symbol will be made. In response to an increase in the user's bet amount, the lines become effective, for example, in the sequence of line (1), line (2), line (3), line (4), and line (5). When a user makes a bet on the line, the symbol indicated at both ends of each line h1 or the thin line part h2 indicates that the line has become effective, by lighting or flashing.

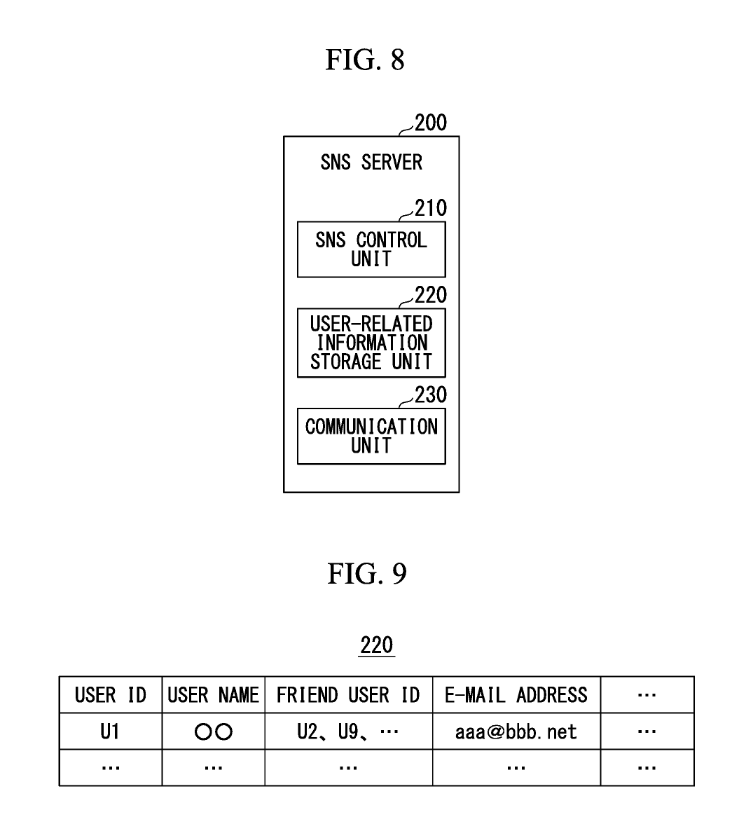

FIG. 8 shows an example of the functional configuration of the SNS server 200. The SNS server 200 is a computer providing the SNS to a user and may include, for example, but is not limited to, a SNS control unit 210, a user-related information storage unit 220, and a communication unit 230. The SNS control unit 210 may include, for example, but is not limited to, the function of a web server, and provides an SNS to a user, based on a pre-established program. The user-related information storage unit 220 stores information related to users who are members of the SNS.

FIG. 9 shows an example of user-related information stored in the user-related information storage unit 220. The user-related information may include, for example, but is not limited to, user IDs, user names, friend user IDs, and e-mail addresses. The user ID is information used in an SNS to identify a user. The user name is the name of the corresponding user, for example, the account name of the user of the SNS. The friend user ID is another user ID associated in the SNS. For example, control is performed so that various information in the SNS is shared between users who are associated as friend users. The e-mail address is the corresponding user's e-mail address. The communication unit 230 may be configured to communicate with another computer connected via the network 5. Using the above-noted configuration, the SNS server 200 performs processing so as to provide an SNS to users via the user terminals 100, and relays communication between a user terminal 100 and the game server 300. In the present embodiment, communication between a user terminal 100 and the game server 300 is performed via the SNS server 200. The user-related information storage unit 220 may be provided in a database server physically separate from the SNS server 200.

### [Configuration of the Game Server 300]

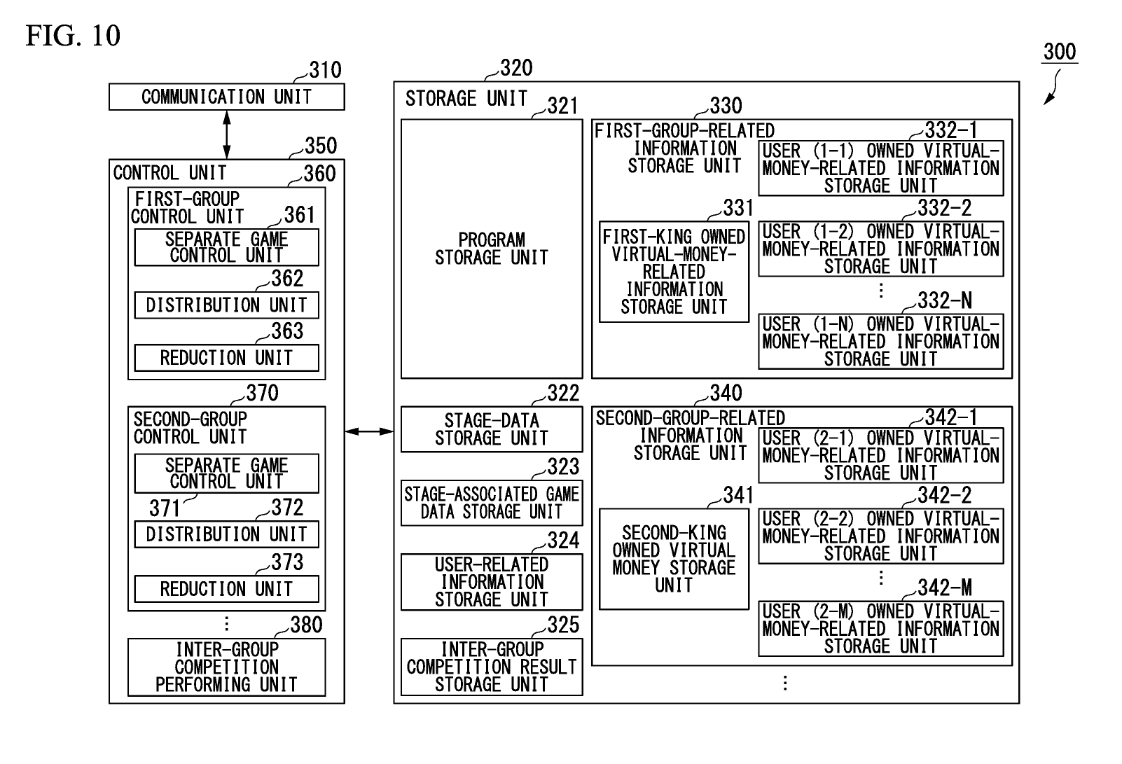

FIG. 10 shows an example of the functional configuration of the game server 300. The game server 300 is a computer that provides a game that operates on an SNS and may include, for example, but is not limited to, a communication unit 310, a storage unit 320, and a control unit 350. The communication unit 310 may be configured to communicate with another computer connected via the network 5.

The storage unit 320 may include, for example, but is not limited to, a program storage unit 321, a stage-data storage unit 322, a stage-associated game data storage unit 323, a user-related information storage unit 324, an inter-group competition result storage unit 325, a first-group-related information stage unit 330, and a second-group-related information storage unit 340. If there are three or more registered groups, the storage unit 320 further includes a third-group-related information storage unit, a fourth-group-related information storage unit, and so on. A part or all of the storage units provided in the storage unit 320 may be provided in a database server physically separate from the storage unit 320.

The program storage unit 321 may be configured to store various programs executed by the control unit 350. The stage-data storage unit 322 may be configured to store the hierarchical structure of the above-described plurality of stages. The stage-associated game data storage unit 323 may be configured to store stage-associated play, slot machine game forms (to be described later) and the like.

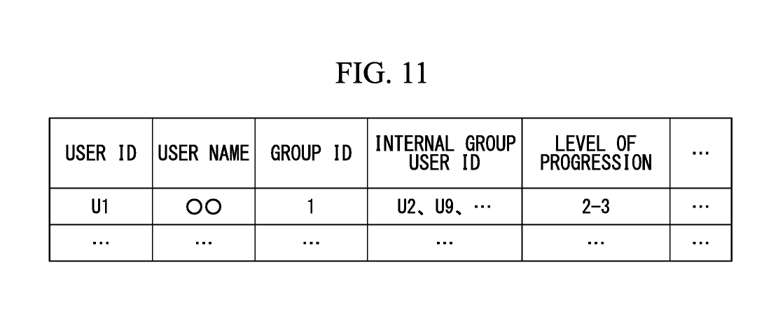

FIG. 11 shows an example of user-related information stored in the user-related information storage unit 324. The user-related information stored in the user-related information storage unit 324 mat include, but is not limited to, for example, user IDs, user names, group IDs, internal group user names, and levels of progression. The user ID may be information used to identify a user playing a game provided by the game server 300. The user ID may be the same as the user ID in the SNS provided by the SNS server 200, or may be a different user ID that is assigned. The user name may be the name of the corresponding user, for example, the account name established within the game. The user name may be the same as the user name in the SNS provided by the SNS server 200, or may be different. The group ID may be information for identifying a group to which the user belongs. The internal group user IDs may be user IDs of the other users belonging to the same group as the user. The user, for example, by performing a predetermined operation on the user terminal 100, can register the group to which the user belongs into the game server 300. The level of progression may be information indicating the stage currently being played by the user.

Referring back to FIG. 10, the functional configuration will be described. The first-group-related information storage unit 330 may include, but is not limited to, a first-king-owned-virtual-money-related information storage unit 331, a user (1-1)-owned-virtual-money-related information storage unit 332-1, a user (1-2)-owned-virtual-money-related information storage unit 332-2, . . . , and a user (1-N)-owned-virtual-money-related information storage unit 332-N. King (1) means the king of group 1. The second-group-related information storage unit 340 may include, but is not limited to, a second-king owned virtual-money-related information storage unit 341, a user (2-1)-owned-virtual-money-related information storage unit 342-1, a user (2-2)-owned-virtual-money-related information storage unit 342-2, . . . , and a user (2-M)-owned-virtual-money-related information storage unit 342-M. King (2) means the king of group 2. Also, information regarding the virtual money owned by a user may be stored in the user-related information storage unit 324. The control unit 350 may include, but is not limited to, a first-group control unit 360, a second-group control unit 370 and an inter-group competition performing unit 380. If three or more groups are registered, the control unit 350 further may include, but is not limited to, a third-group control unit, and fourth-group control unit, and so on. The first-group control unit 360 may include, but is not limited to, a separate game control unit 361, a distribution unit 362, and a reduction unit 363. The second-group control unit 370 may include, but is not limited to, a separate game control unit 371, a distribution processing 372, and a return unit 373.

The above-noted functional units will be described below. As a general rule, the separate game control units 361 and 371, the distribution units 362 and 372, and the return units 363 and 373 perform the same processing. If three or more groups exist, this applies to the control units of the three or more groups. In the description that follows, only the separate game processing unit 361, the distribution unit 362, and the reduction unit 363 of the first-group control unit 360 will be described, the description of the control units for the other groups being omitted.

### [Separate Game Control]

The separate game control unit 361 may be configured to provide one or more separate games to a user via the user terminal 100. In this case, the separate game control unit 361 may be configured to provide at least a separate game to a user belonging to group 1. Therefore, the separate game control unit 361 one or more provide a game to users via the user terminals 100-1-1, 100-1-2, . . . , 100-1-N and, in the description to follow, no particular distinction will be made, the terminal being referred to simply as the user terminal 100. The user bets his own virtual money to the slot machine game as a separate game, and in addition to this, the user can purchase various items that provide an advantage in a slot machine game with the virtual money owned by doing this, by the user spending (reducing) the user's own virtual money, it is possible, in accordance with the result of slot machine game, to win a payout exceeding the virtual money spent, thereby increasing the amount of virtual money owned.

### [Items]

The separate game control unit 361 may be configured to provide the following types of item, which can be purchased by a user, as various items that provide an advantage in a slot machine game.

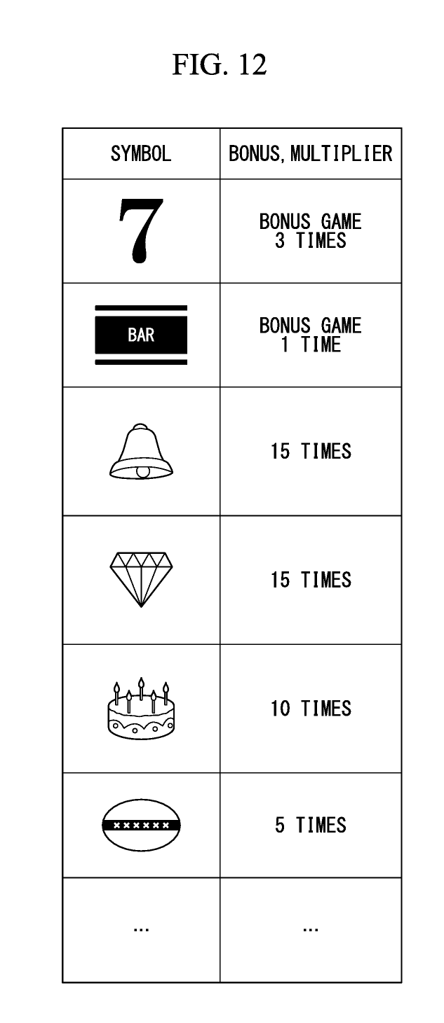

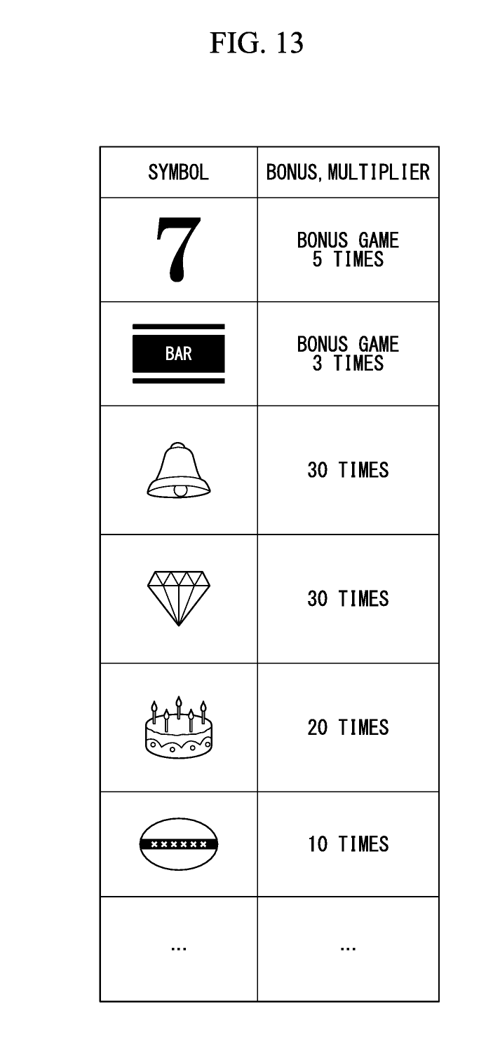

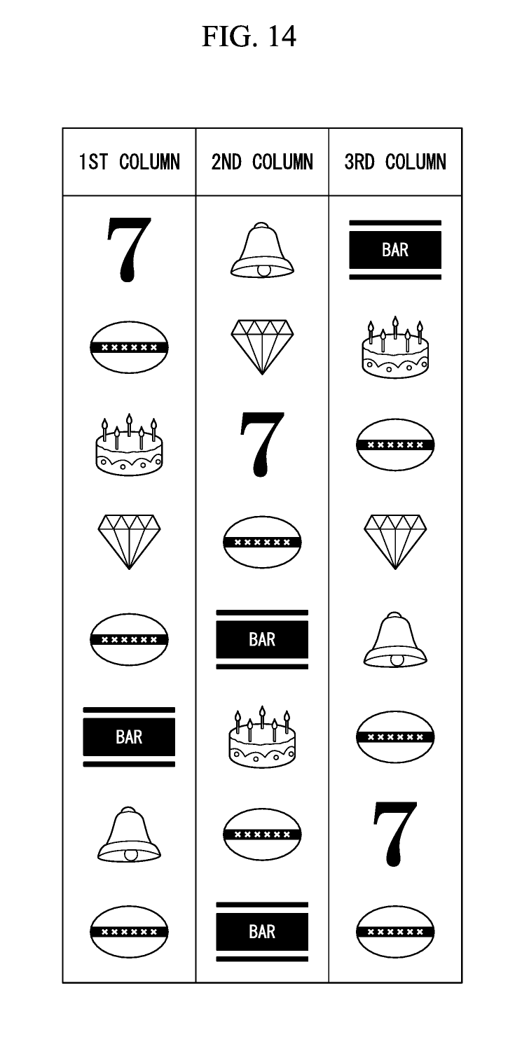

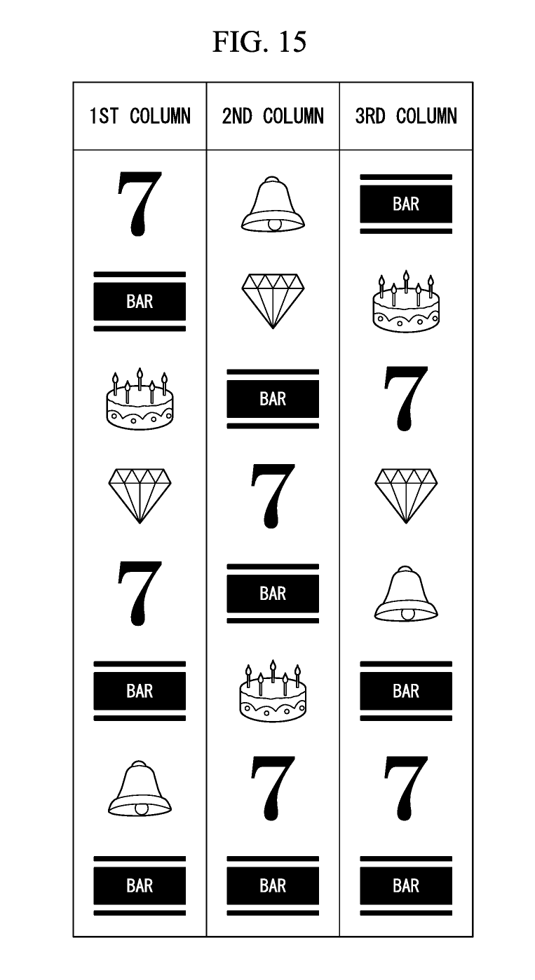

(1) The separate game control unit 361 may be configured to create a condition in which a user can purchase an item that changes a payout table or a symbol table (arrangement of symbols in the reel unit) to be advantageous to the user. FIG. 12 shows a usual payout table. FIG. 13 shows a payout table that has been changed to be to the advantage of a user. In FIG. 12 and FIG. 13, the “bonus game” may be, for example, a game that is set so that a condition in which a high win probably exists with a minimum number of bets continues for a predetermined number of times. In the payout table shown in FIG. 13, the multipliers and bonuses as payouts for an arrangement of the same symbols are more advantageous than those as shown in FIG. 12. FIG. 14 shows a usual symbol table. FIG. 15 shows a table with symbols changed to the advantage of the user. The symbol table shown in FIG. 15 has a higher proportion of the symbol “7” and the “BAR” logo in each reel than in the symbol table shown in FIG. 14, making it easier to get a bonus game.

(2) The separate game control unit 361 may be configured to create a condition in which a user can purchase an item that makes it possible to obtain the same bonus or payout with a fewer number of bets than usually. When this item is used, for example, whereas a bet amount of five units is usually required with respect to five effective lines, a bet value of only one unit is required with respect to five effective lines.

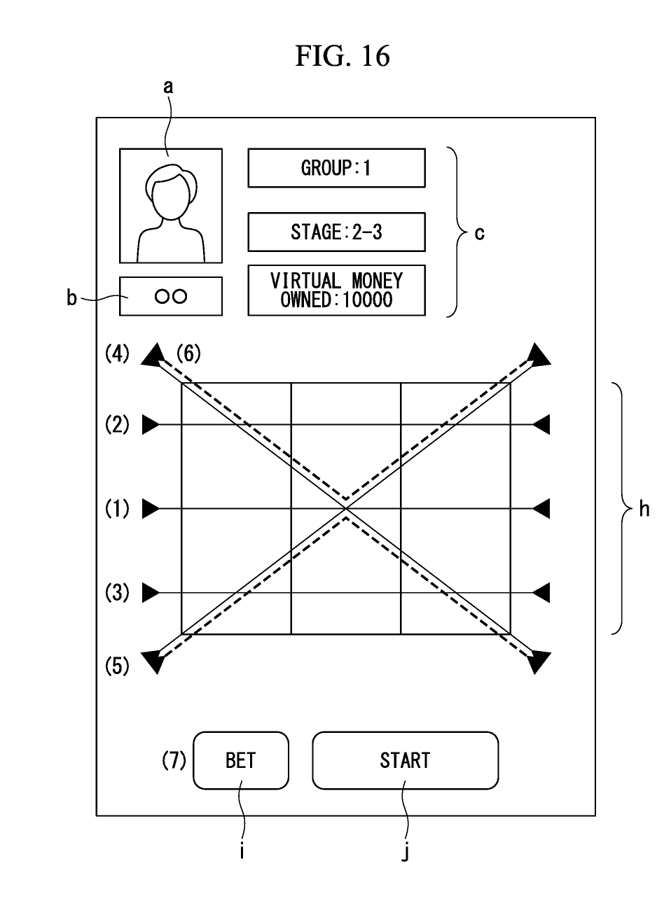

(3) The separate game control unit 361 may be configured to allow a user to purchase an item that increases the number of effective lines. By using this item, for example, in addition to lines which are effective in a condition in which items in the horizontal or inclined directions are not used, lines such as the V-shaped line shown in FIG. 16 are made effective, making it easier to achieve an arrangement of symbols. FIG. 16 is a schematic representation of the condition in which effective lines are to be added. In FIG. 16, the dashed lines indicated at (6) and (7) are examples of added effective lines. With regard to the added effective lines, the user need not be required to increase the bet amount or, alternatively, may be required to add to the bet amount.

(4) The separate game control unit 361 may be configured to allow the user to purchase an item that increases the number of games that can be played per unit time. The maximum number of slot machine games that can be played, for example, per hour, may be established, in which case, by using this item, the maximum number of playable games is increased.

(5) The separate game control unit 361 may be configured to allow the user to purchase an item that eases the stage clearing condition. By using this item, the clearing condition, for example, for the stage currently being played, is eased.

### [Stage Clearing Condition]

The separate game control unit 361 may be configured to set the following conditions as the stage clearing condition.

(a) The separate game control unit 361 may be configured to set the arrangement of a particular symbol a predetermined number of times as the stage clearing condition.

(b) The separate game control unit 361 may be configured to set the winning of a predetermined amount in a slot machine game (the reaching of a predetermined amount of distribution, without considering reduction by betting) as the stage clearing condition.

(c) The separate game control unit 361 may be configured to set the achievement of a predetermined amount of virtual money owned as the stage clearing condition.

(d) The separate game control unit 361 may be configured to set playing a slot machine game a predetermined number of times as a stage clearing condition.

Data regarding these items and data regarding the stage clearing condition are stored in, for example, the stage-associated game data storage unit 323.

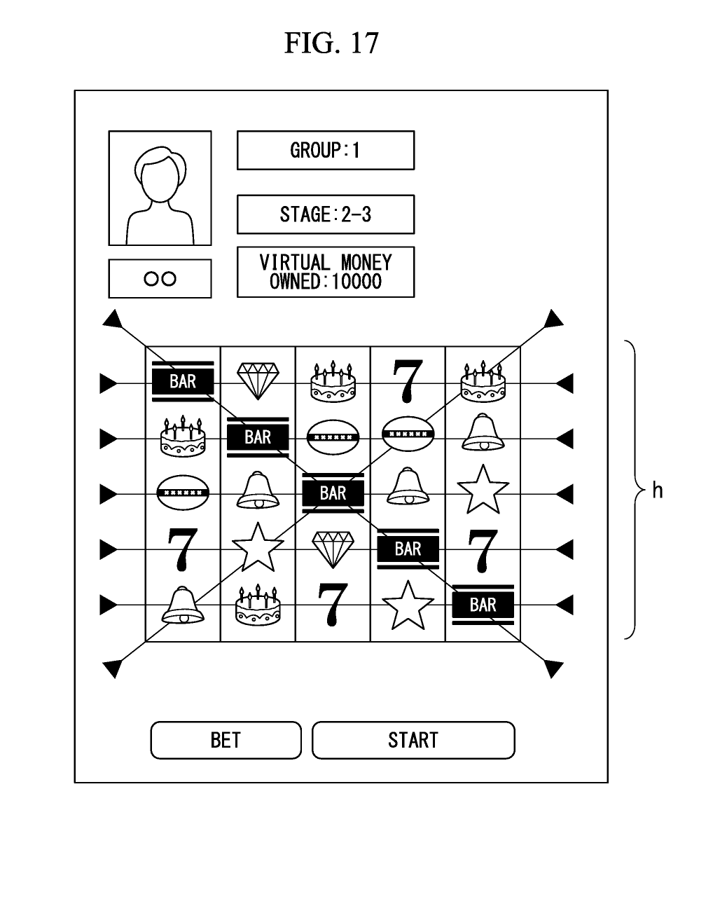

The separate game control unit 361 may be configured to change the mode or form of the slot machine game in response to the stage progression. FIG. 17 shows an example of the play screen of a slot machine game when the mode or form of the slot machine game is changed. Data for such a screen is transmitted to the user terminal 100 and is displayed on the display unit 130 of the user terminal 100. As shown in FIG. 17, the separate game control unit 361 may be configured to change the slot machine game, for example, from one with three columns to one with five columns as the stages progress, for example, upon clearing a predetermined stage. By doing this, the separate game control unit 361 can impart feeling of freshness to the player. Also, the changing of the mode or form of the slot machine game is not restricted to the above, and may be done by changing the symbols, the symbol tables, the payout tables, the image effect, characters, voices, or the like.

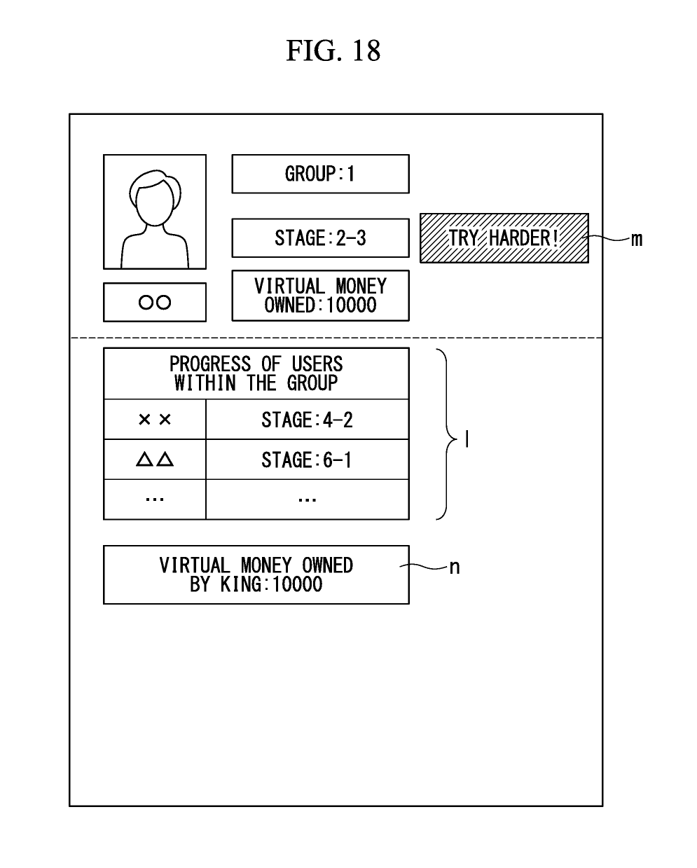

The separate game control unit 361 may be configured to provide the user with the level of progress through the stages of other users within the group, for example, in response to a user operation or automatically at, for example, the time of clearing a stage. FIG. 18 shows an example of a screen that shows a user the progress through the stages of other users within the groups. Data for such a screen is transmitted to the user terminal 100 and is displayed on the display unit 130 of the user terminal 100. In FIG. 18, the region 1 may be configured to display the progress through the stages of other users within the group. The region m may be configured to display a message responsive to the progress through stages of the user of the user terminal 100 in comparison with the progress through stages of other users within the group. In the screen shown in FIG. 18, the region n may be configured to display the virtual money owned by the group's king. In this manner, the progress through stages of other users within the group can be displayed and the group can be driven to cohesiveness, thereby providing motivation to the user to play the game.

### [Distribution Processing]

The distribution unit 362 may be configured to perform distribution processing, in accordance with the virtual money owned by king (1), so that at least a part of the virtual money owned by king (1) is distributed to the users (1-1), (1-2), . . . , (1-N) belonging to group 1 as virtual fighting money. The distributed fighting virtual money is added to the virtual money owned by the users (1-1), (1-2), . . . , (1-N). The virtual money owned by king (1) and the users (1-1), (1-2), . . . , (1-N), as shown in FIG. 10, is stored in the first-king-owned-virtual-money-related information storage unit 331, the user (1-1)-owned-virtual-money-related information storage unit 332-1, the user (1-2) owned-virtual-money-related information storage unit 332-2, . . . , user (1-N)-owned virtual-money-related information storage unit 332-N, and so forth.

The distribution unit 362 may be configured to impart a feeling of togetherness to users within a group, in accordance with the virtual money owned by king (1), so as to enhance enjoyment of the game. This is because, the distribution to users increases if the virtual money owned by king (1) becomes a large amount, it is possible to impart the motivation to the users to win a lot of virtual money in separate games and increase the amount of virtual money owned by the king, thereby increasing the distribution within the group.

The distribution unit 362 may be configured to distribute a given proportion of the virtual money owned by king (1) uniformly to the users belonging to group 1. The distribution may be periodical, for example, one every several hours, once daily, once every over day, or once weekly. There is no restriction to this, and a larger distribution may be made to a user who has returned a larger amount of virtual money to king (1) in the past. As a combination of these, the distribution unit 362 may be configured to perform a uniform distribution at the time the group is formed, for example, for approximately several days after the registration of the group and, as separate games by users belonging to the group progress, a larger distribution may be made to a user who has returned a larger amount of virtual money to king (1) in the past. The amount of virtual money subtracted from the virtual money owned by king (1) need not coincide with the total amount distributed to users. For example, a thousand units may be subtracted from the virtual money owned by king (1) and 150 units may be distributed to each of ten users.

### [Changing the Method of Calculating Distributed Amount]

Additionally, the distribution unit 362 may be configured to change the method of calculating the amount distributed to the users, based on a comparison between the virtual money owned by king (1) of its own group (the group it is controlling) and the king of another group. In this case, for example, the smaller is the virtual money owned by its own king (1) compared to that of the king of another group, the larger the distribution unit 362 adjusts the relative distribution amount with respect to the king's owned virtual money. This processing has as a premise that the expected value of the slot machine game is greater than 10%, that is, that the user's virtual money owned will increase the more the user plays. With this as premise, the more the distributed amount increases, the more plays the user will make and the more items giving a slot machine game advantage will the user be able to purchase, enabling a further increase in the virtual money owned by the user. Because a user's virtual money is returned to the virtual money owned by king (1), distributing more virtual money to the user has the result of leading to an increase in the virtual money owned by king (1). As a result, if the virtual money owned by king (1) of its own group is less than the virtual money owned by a king of another group, the distribution unit 362 can guide in the direction that increases the virtual money owned by king (1) of its own group, enabling balancing of the intergroup competition for virtual money owned by doing this, the distribution unit 362 can heat up the competition between groups, and enhance enjoyment of the game. This is not restricted to the distribution unit 362, but is rather the same with regard to the distribution unit 372 and any distribution units for the third and subsequent groups.

Methods of “adjustment so that the distribution increases” that can be envisioned are the method of increasing the amount distributed each time, proportion of distribution with respect to the virtual money owned by king (1), in making periodic distributions, the method of increasing the frequency of distribution, the method of increasing the ratio of the amount distributed to a user relative to the amount of reduction of the virtual money owned by the king, and combinations of these methods.

It could be that the definitions of virtual money owned differ between groups, for example, if both a yen-based group and a dollar-based group exist, or that, rather than “virtual money” owned, there is a group in which distribution and return are done of items or the like. In these cases, the distribution unit 362 performs a comparison after adjustment to the same values using a predetermined conversion standard, for example, a virtual exchange rate.

The following descriptions will be involved in a method of changing the method of calculating the amount to be distributed, based on a comparison between the virtual money owned by the group's own king (1) and that owned by the king of another group.

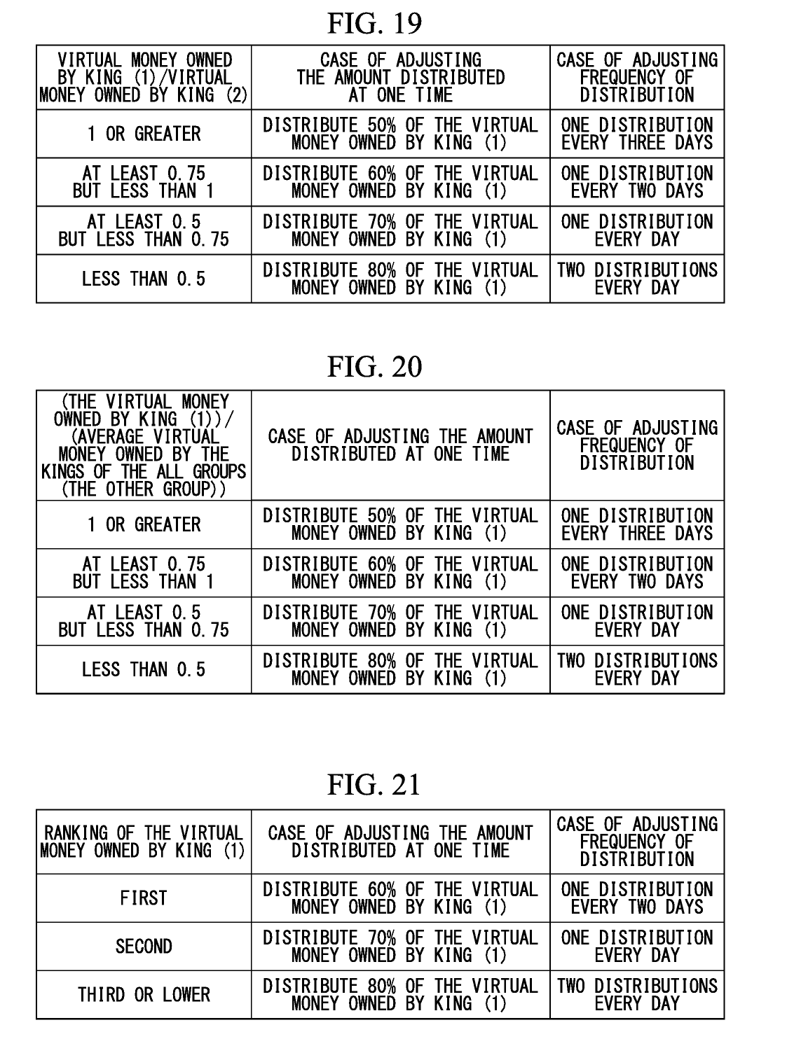

(1) If there are two registered groups, the distribution unit 362, for example, sets a threshold value with respect to the ratio between the virtual money owned by the group's own king (1) and the virtual money owned by the king of another group, and distributes virtual money owned by king (1) in accordance with the ratio and the threshold value. FIG. 19 shows an example of the relationship of correspondence between the ratio of the virtual money owned by king (1) and the distributed amount. As shown in FIG. 19, in the case of adjusting the amount distributed at one time, for example, if the ratio of the virtual money owned by king (1) divided by the virtual money owned by king (2) is 1 or greater, the distribution unit 362 distributes 50% of the virtual money owned by king (1) to the users. The distribution unit 362, for example, distributes 60% of the virtual money owned by king (1) to the users if the ratio is at least 0.75 but less than 1, distributes 70% of the virtual money owned by king (1) to the users if the ratio is at least 0.5 but less than 0.75, and distributes 80% of the virtual money owned by king (1) to the users if the ratio is less than 0.5. If the frequency of distribution is being adjusted, the distribution unit 362, for example, makes one distribution every three days if the ratio if the ratio is 1 or greater, makes one distribution every two days if the ratio is at least 0.75 but less than 1, makes a distribution every day if the ratio is at least 0.5 but less than 0.75, and makes two distributions every day if the ratio is less than 0.5. The distribution unit 362 may vary both the distributed amount and the frequency of distribution in accordance with the ratio.

If there are two groups, the distribution unit 362 may vary the distributed amount in two steps, based on simply whether or not the virtual money owned by king (2) of another group exceeds the virtual money owned by king (1) of its own group. Also, if there are two groups, the distribution unit 362 may vary the distributed amount in two steps, based on whether or not an inter-group competition was won or lost. Because the result of inter-group competition reflects the virtual money owned by the king of the group itself and the virtual money owned by the king of another group at the time of executing the competition, variation of the distributed amount based on the result of an inter-group competition is indirectly variation of the distributed amount based on the amount of virtual money owned by the king of the group itself and the king of another group. This applies as well if there are three or more groups.

(2) If there are three or more registered groups, the distribution unit 362, for example, sets a threshold value with respect to the ratio between the virtual money owned by king (1) of its own group and the average virtual money owned by the kings of the all groups (or the average of the virtual money owned by the kings of the other groups), and distributes virtual money owned by king (1) in accordance with the relationship between the ratio and the threshold value. FIG. 20 shows an example of the relationship of correspondence between the ratio of the virtual money owned by king (1) and the threshold value. As shown in FIG. 20, if the amount distributed at one time is being adjusted, for example, if the ratio of the virtual money owned by king (1) divided by the average virtual money owned by the kings of all groups is 1 or greater, the distribution unit 362 distributes 50% of the virtual money owned by king (1) to the users. The distribution unit 362 distributes 60% of the virtual money owned by king (1) if the ratio is at least 0.75 but less than 1, distributes 70% of the virtual money owned by king (1) if the ratio is at least 0.5 but less than 0.75, and distributes 80% of the virtual money owned by king (1) if the ratio is less than 0.5. If the frequency of distribution is being adjusted, the distribution unit 362 makes one distribution every three days if the ratio is at least 1, makes one distribution every two days if the ratio is at least 0.75 but less than 1, makes one distribution every day if the ratio is at least 0.5 but less than 0.75, and makes two distributions every day if the ratio is less than 0.5. The distribution unit 362 may vary both the distributed amount and the frequency of distribution in accordance with the ratio.

(3) If there are three or more registered groups, the distribution unit 362, for example, distributes the virtual money owned by king (1) based on the ranking of the virtual money owned by king (1) of its own group. FIG. 21 shows an example of the relationship of correspondence between the ranking of the virtual money owned by king (1) and the distributed amount. In this case, the ranking of the virtual money owned may be the ranking of virtual money owned at that point in time, or may be the results of the immediately previous inter-group competition. As shown in FIG. 21, in the case of adjusting the amount distributed at one time, for example, if the virtual money owned by king (1) is ranked as first among all of the groups, the distribution unit 362 distributes 60% of the virtual money owned by king (1) to the users. The distribution unit 362 distributes 70% of the virtual money owned by king (1) if the ranking of the virtual money owned by king (1) is second, and distributes 80% of the virtual money owned by king (1) if the ranking of the virtual money owned by king (1) is third or lower. In the case of adjusting the frequency of distribution, for example, the distribution unit 362 makes one distribution every two days if the ranking of the virtual money owned by king (1) is first, makes one distribution every day if the ranking of the virtual money owned by king (1) is second, and makes two distribution every day if the ranking of the virtual money owned by king (1) is third or lower. The distribution unit 362 may vary both the distributed amount and the frequency of distribution in accordance with the ranking.

Although it might happen that the definition of virtual money owned by a king differs from the definition of virtual money owned by a user, or that an item in accordance with the virtual money owned by a king is distributed to a user, or that the definition of virtual money differs between users belonging to the same group, in these cases the distribution unit 362 may make the distribution after using a predetermined conversion standard to convert to the value distributed to the user.

### [Return Processing]

Return processing is one example of a reduction process to reduce virtual value owned by a user. Reduction process to reduce or decrease the amount of virtual value owned by a user should not be limited to the return processing to be described below. The reduction unit 363 may be configured to perform return processing to return at least a part of the virtual money owned by the users (1-1) (1-2), . . . , (1-N) to the virtual money owned by king (1). The rules for return processing may be arbitrarily established so that, with a period of one time every day, one time every several days, or one time every week, a predetermined proportion of the virtual money owned by each user is returned to the virtual money owned by king (1). In the return processing as well, adjustment may be done based on the ratio between the virtual money owned by king (1) of its own group with the virtual money owned by kings of other groups, in which case, if its own king (1) own less virtual money than the virtual money owned by kings of another group, the returned amount is made small, thereby leaving more virtual money owned by the users. By doing this, similar to distribution processing, it is possible to balance the virtual money owned between groups.

### [Inter-Group Competition]

The inter-group competition performing unit 380 may be configured to perform, for example, with a predetermined period, an inter-group competition that compares the virtual money owned by the king of each group, and displays the results on each of the user terminals 100. As described above, although there can be cases in which there are differences in the definition of virtual money owned between groups or in which there are groups with not virtual money, but rather items that are distributed and returned. In these cases, the inter-group competition performing unit 380 may be configured to make the comparison after using a predetermined conversion standard to adjust to the same value. The inter-group competition performing unit 380 may be configured to cause the inter-group competition result storage unit 325 to store the result of the inter-group competition. The reduction unit 363 may be configured to collect all the virtual money owned by all of the users and return it to the king, before the inter-group competition is executed. In this case, the collected virtual money of each of the users is, for example, returned to respective users after the performing of the inter-group competition. Inter-group competition may be performed in the form of an amount that is the total of the virtual money owned by the king of a group and owned by each user in the group being compared with another group.

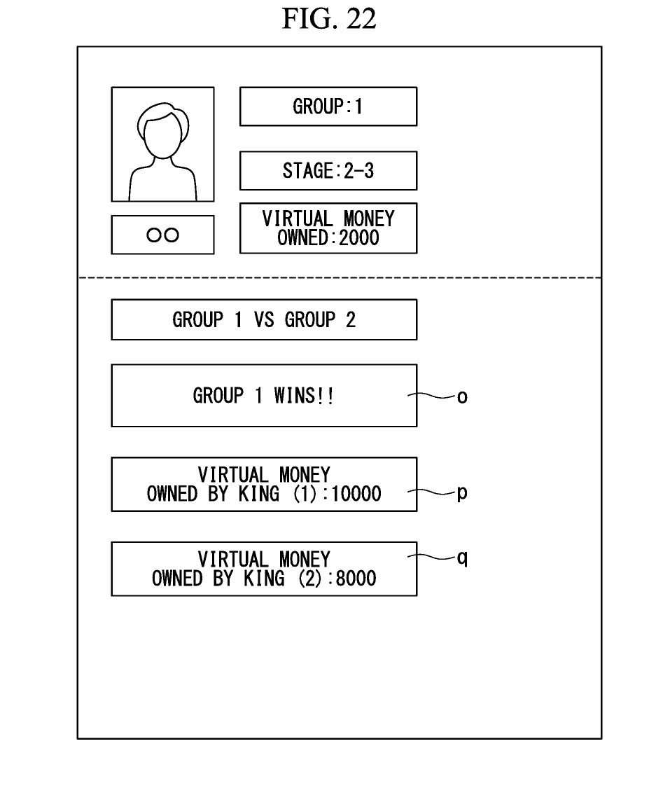

If there are two registered groups, the inter-group competition performing unit 380 may, for example, take a group having the greater amount of virtual money owned by the king as having won and the group having the lesser amount of virtual money owned by the king as having lost. FIG. 22 shows an example of a display screen displaying the results of inter-group competition for the case of two registered groups. In FIG. 22, the win/lose result of a group (group 1) to which the user belongs is displayed in region o. The virtual money owned by king (1) of the user's group, in this case, the group to which the user belongs, is displayed in region p, and the virtual money owned by king (2) of the other group is displayed in the region q. Data for such as screen is transmitted to the user terminal 100 and is displayed on the display unit 130 of the user terminal 100. By doing this, users of both groups are spurred on to compete, enabling the imparting of motivation to play the game.

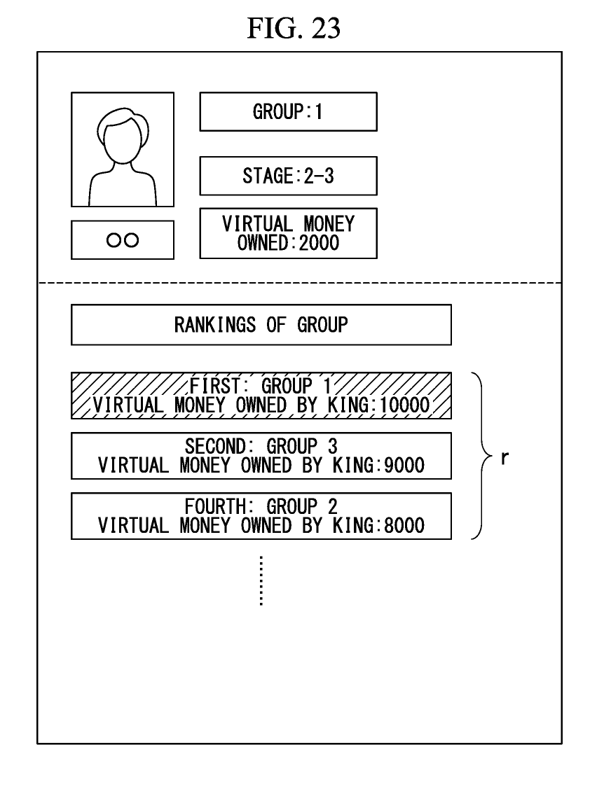

If there are three registered groups, the inter-group competition performing unit 380 may, for example, disclose the ranking of the virtual money owned by the kings. FIG. 23 shows an example of the display screen displaying the results of inter-group competition for the case in which there are three or more registered groups. In FIG. 23, for example, the rankings of each group are displayed in association with the virtual money owned by the kings. Data for such as screen is transmitted to the user terminal 100 and is displayed on the display unit 130 of the user terminal 100. By doing this, users of each group are spurred on to compete, enabling the imparting of motivation to play the game.

An item providing an advantage in a separate game may be given to a group having won in an inter-group competition, or to a user who belongs to a group that has achieved a high ranking. By doing this, it is possible to impart motivation to play the game.

### [Processing Flow]

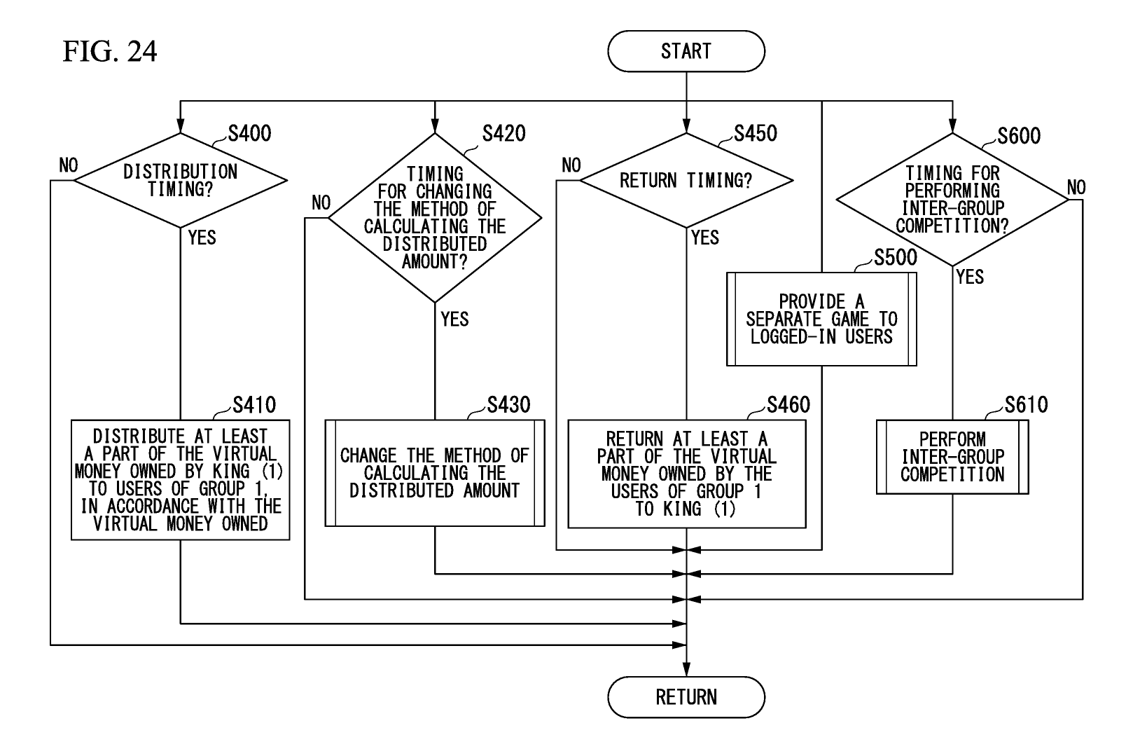

The flow of the processing executed by the control unit 350 of the present embodiment will be described below. FIG. 24 to FIG. 33 are flowcharts showing the flow of the processing executed by the control unit 350. The processing in these flowcharts, for example, may be executed repeatedly with a predetermined period, or each processing may be executed by interrupt notification.

FIG. 24 to FIG. 31 show the flow of the processing executed by the first-group control unit 360 and, with regard to steps S600 and S610, the inter-group competition performing unit 380, the same processing being done as well in the second-group control unit 370. Also, if there are three or more registered groups, the same processing is done by the control unit for group 3 and so on.

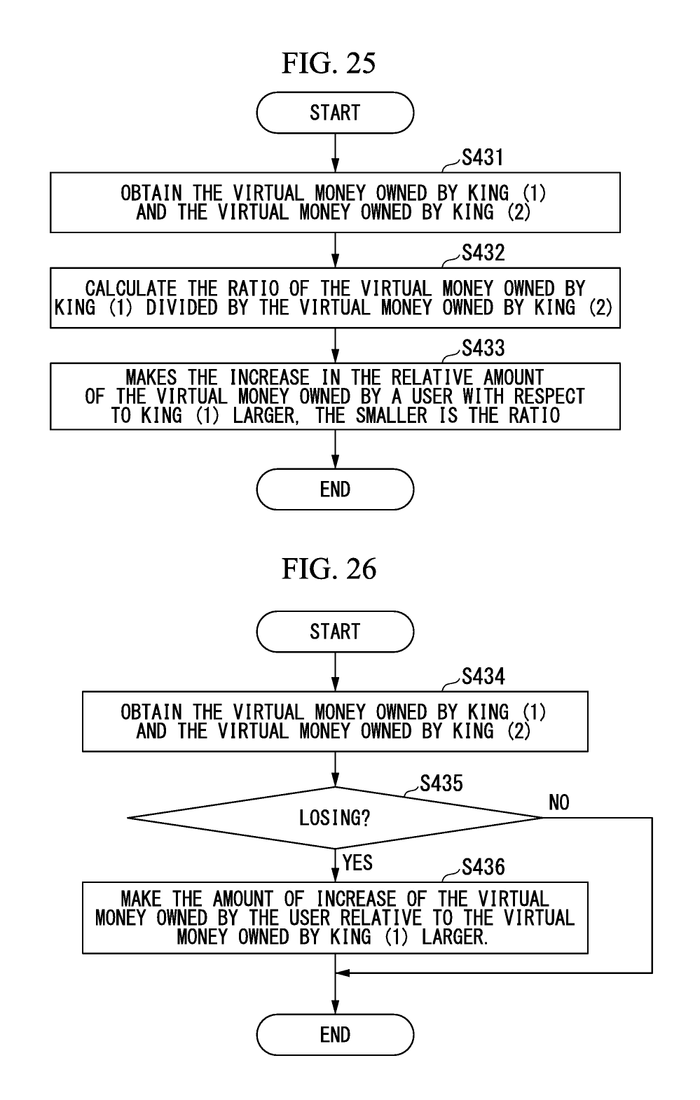

The flowchart of FIG. 24 will now be described. The distribution unit 362 judges whether or not the distribution timing for executing distribution processing has arrived (step S400). The distribution timing, as described above, for example, occurs periodically. If the distribution times are made to be different for each group, it arrives with a different period for each group. If the distribution timing arrives, the distribution unit 362, based on the method for calculating the distributed amount determined at that point in time and in accordance with the virtual money owned by king (1) makes a distribution of at least a part thereof to users of group 1 (step S410). The distribution unit 362 judges whether or not the timing for changing the method of calculating the distributed amount has arrived (step S420). The timing for changing the method of calculating the distributed amount may, for example, arrive periodically, or may arrive immediately after an inter-group competition is performed. The timing of the changing of the method of calculating the distributed amount may be made to coincide with the distribution timing (more specifically, the distributed amount calculation method is changed immediately before the distribution timing, and this is reflected in the distribution processing). When the timing of changing the method of calculating the distributed amount arrives, the distribution unit 362 changes the method of calculating the distributed amount (step S430). The processing for changing the method of calculating the distributed amount will be described by FIG. 25 to FIG. 30.

The reduction unit 363 judges whether or not the return timing at which return processing is to be executed has arrived (step S450). The return timing arrives, for example, as described, periodically. When the return timing arrives, the reduction unit 363 returns at least a part of the virtual money owned by the users of group 1 to king (1) (step S460).

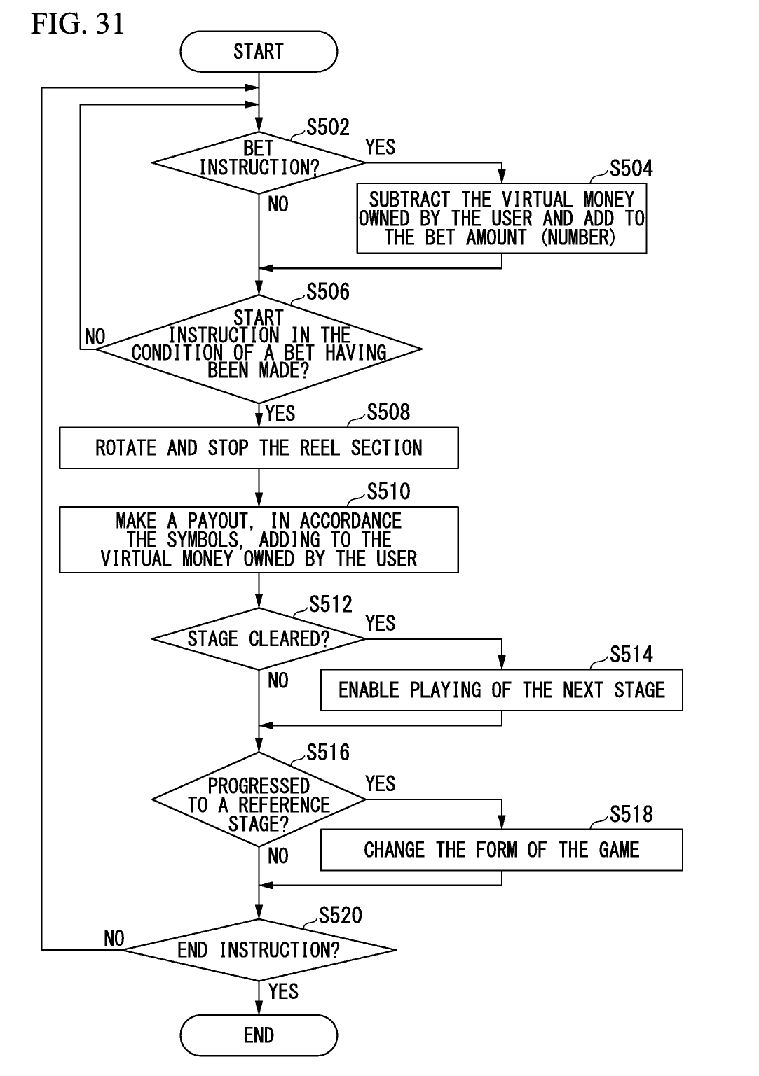

The separate game control unit 361 provides a separate game to users who are logged into the game system (step S500). The processing regarding provision of the separate game will be described by FIG. 31.

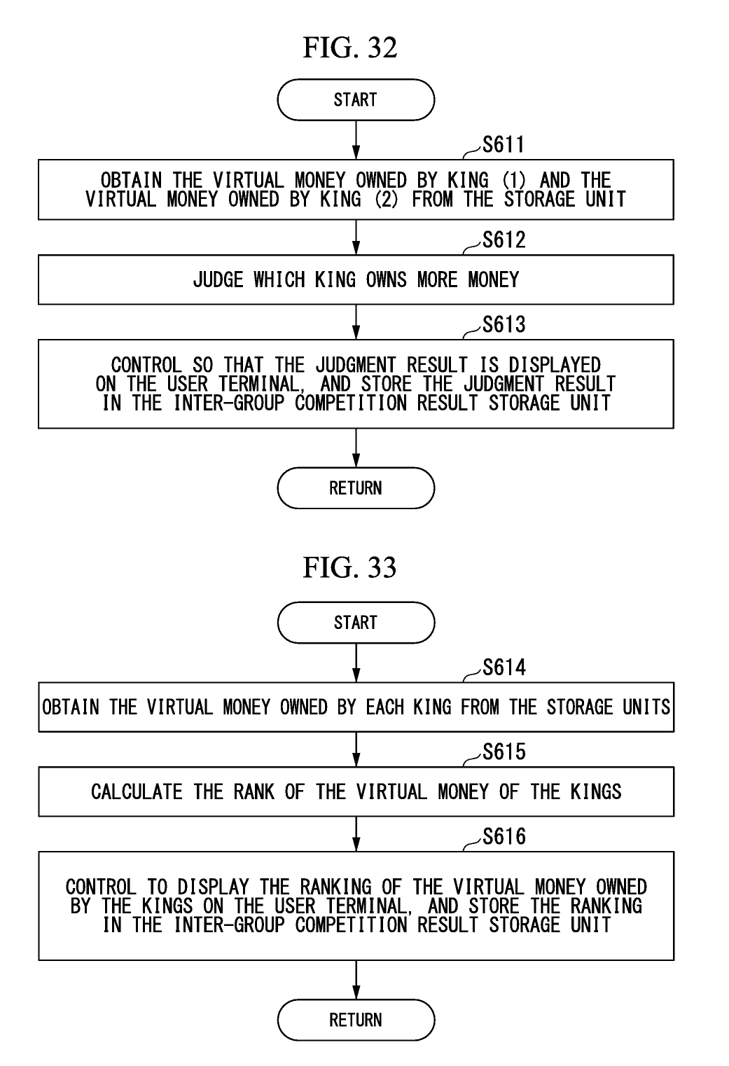

The inter-group competition performing unit 380 judges whether or not the inter-group competition performing timing for performing of inter-group competition has arrived (step S600). When the inter-group competition performing timing arrives, the inter-group competition performing unit 380 executes inter-group competition (step S610). The processing regarding inter-group competition will be described by FIG. 32 and FIG. 33.

FIG. 25 to FIG. 27 each show examples of the flow of processing by the distribution unit 362 to change the method of calculating the distributed amount for the case in which two groups performed the inter-group competition. The distribution unit 362 may adopt either of the processing flows shown in these examples.

The flow of FIG. 25 will now be described. The flow of FIG. 25 is an example of a flowchart showing the flow of processing executed by the distribution unit 362 to change the method of calculating the distributed amount. First, the distribution unit 362 obtains the virtual money owned by king (1) and the virtual money owned by king (2) from the first-king owned virtual-money-related information storage unit 331 and the second-king owned virtual-money-related information storage unit 332, respectively (step S431). Next, the distribution unit 362 calculates the ratio of the virtual money owned by king (1) divided by the virtual money owned by king (2) (step S432). The distribution unit 362 makes the increase in the relative amount of the virtual money owned by a user with respect to king (1) larger, the smaller is the calculated ratio (step S433).

The flow of FIG. 26 will now be described. The flow of FIG. 26 shows another example of a flowchart showing the flow of processing executed by the distribution unit 362 to change the method of calculating the distributed amount. First, the distribution unit 362 obtains from the first-king-owned-virtual-money-related information storage unit 331 and the second-king-owned-virtual-money-related information storage unit 341 the virtual money owned by king (1) and the virtual money owned by king (2), respectively (step S434). Next, the distribution unit 362 judges whether the virtual money owned by king (1) is losing to the virtual money owned by king (2), that is, whether the virtual money owned by king (1) is less than the virtual money owned by king (2) (step S435). If the virtual money owned by king (1) is losing to the virtual money owned by king (2), the distribution unit 362 increases the amount of increase of the virtual money owned by users relative to the virtual money owned by king (1) (step S436). If the increase in the amount of virtual money of the users relative to the virtual money owned by king (1) is controlled in two steps, the processing of step S436 is the processing to take the calculation method that makes the amount of increase of the virtual money owned by the user relative to the virtual money owned by king (1) larger.

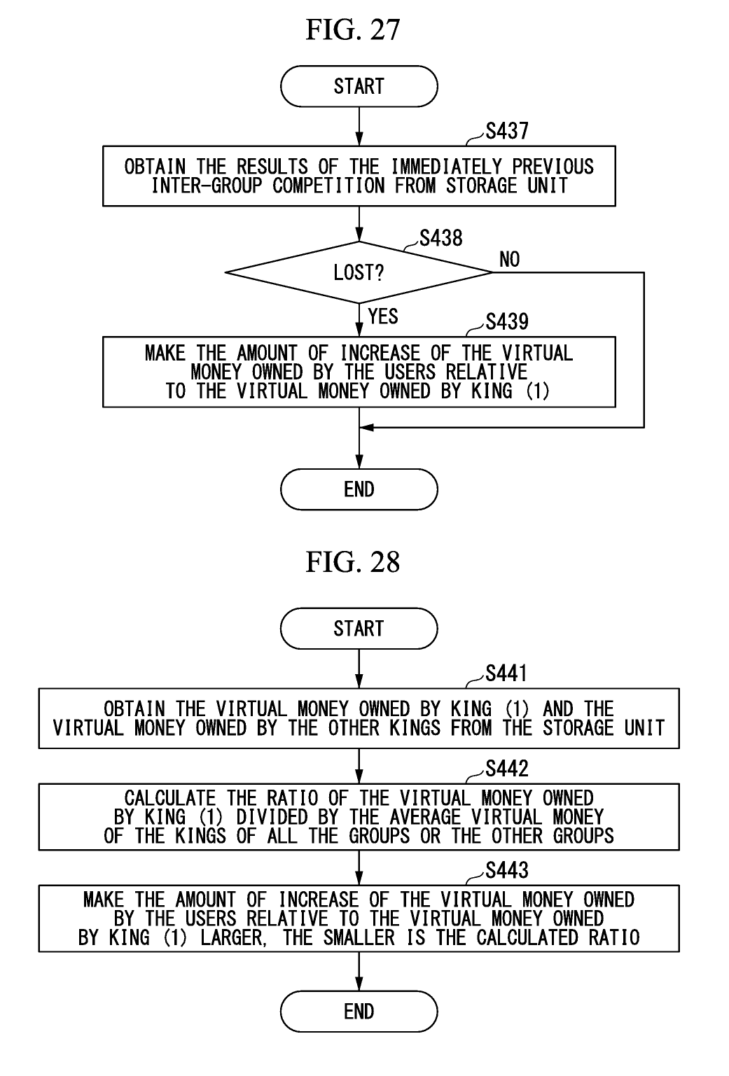

The flow of FIG. 27 will now be described. The flow of FIG. 27 is another example showing the flowchart of the flow of processing executed by the distribution unit 362 to change the method of calculating the distributed amount. First, the distribution unit 362 obtains the results of the immediately previous inter-group competition from the inter-group competition result storage unit 325 (step S437). Next, the distribution unit 362 judges whether or not king (1) lost in the immediately previous inter-group competition (step S438). If king (1) had lost in the immediately previous inter-group competition, the distribution unit 362 makes the amount of increase of the virtual money owned by the users relative to the virtual money owned by king (1) (step S439). If the increase in the amount of virtual money of the users relative to the virtual money owned by king (1) is controlled in two steps, the processing of step S439 is the processing to take the calculation method that makes the amount of increase of the virtual money owned by the users relative to the virtual money owned by king (1) larger.

FIG. 28 to FIG. 30 each shows examples of the flow of processing executed by the distribution unit 362 to change the method of calculating the distributed amount for the case in which three groups or more execute inter-group competition. The distribution unit 362 may adopt any one of the processing flows that are shown in these examples.

The flow of FIG. 28 will now be described. The flow of FIG. 28 is an example of a flowchart showing the flow of processing executed by the distribution unit e62 to change the method of calculating the distributed amount. First, the distribution unit 362 obtains the virtual money owned by king (1) and the virtual money owned by the other kings from the first-king-owned-virtual-money-related information storage unit 331 and the other king-owned-virtual-money-related information storage units (341 and the like), respectively (step S441). Next, the distribution unit 362 calculates the ratio of the virtual money owned by king (1) divided by the average virtual money of the kings of all the groups (or of kings of all the other groups except for its own group) (step S442). Then, the distribution unit 262 makes the amount of increase of the virtual money owned by the users relative to the virtual money owned by king (1) larger, the smaller is the calculated ratio (step S443).

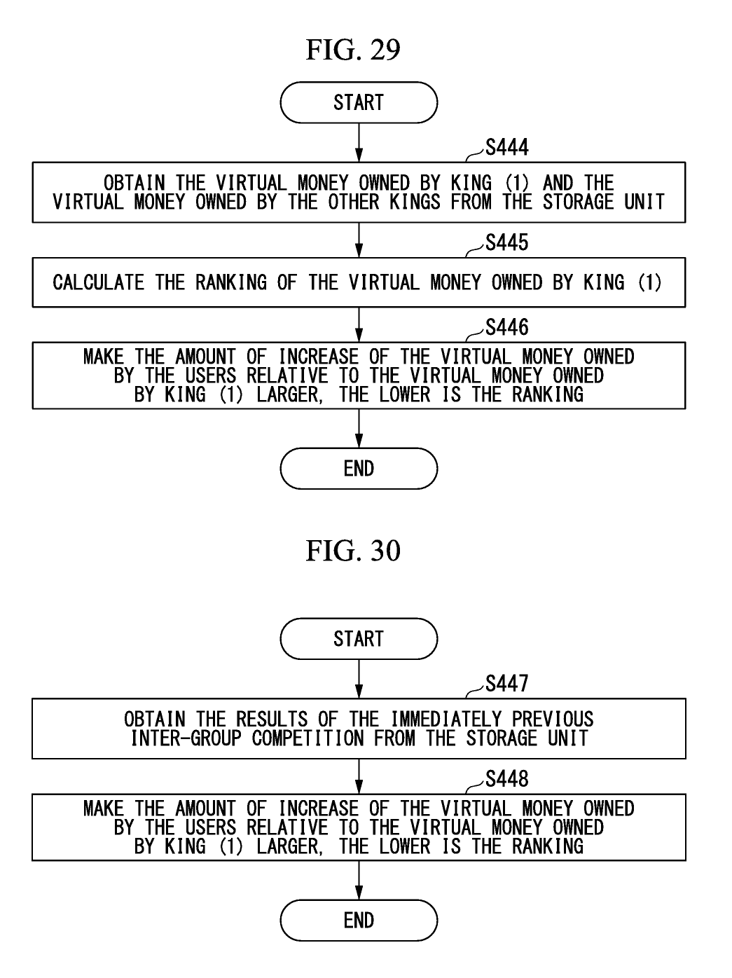

The flow of FIG. 29 will now be described. The flow of FIG. 29 shows another example of a flowchart of the flow of processing executed by the distribution unit 362 to change the method of calculating the distributed amount. First, the distribution unit 362 obtains the virtual money owned by king (1) and the virtual money owned by the other kings from the first-king-owned-virtual-money-related information storage unit 331 and the other king-owned-virtual-money-related information storage units (341 and the like) (step S444), respectively. Next, the distribution unit 362 calculates the ranking of the virtual money owned by king (1) (step S445). Then, the distribution unit 362 makes the amount of increase of the virtual money owned by the users relative to the virtual money owned by king (1) larger, the lower is the ranking of the virtual money owned by king (1) (step S446).

The flow of FIG. 30 will now be described. The flow of FIG. 30 is another example of a flowchart showing the flow of processing executed by the distribution unit 362 to change the method of calculating the distributed amount. First, the distribution unit 362 obtains the results of the immediately previous inter-group competition from the inter-group competition result storage unit 325 (step S447). Then, the distribution unit 362 makes the amount of increase of the virtual money owned by the users relative to the virtual money owned by king (1) larger, the lower is the ranking of the virtual money owned by king (1) in the immediately previous inter-group competition (step S448).

The flow of FIG. 31 will now be described. The flow of FIG. 31 is an example of a flowchart showing the flow of processing executed by the separate game control unit 361 related to providing a separate game. First, the separate game control unit 361 judges whether or not a bet instruction (operation) has been made from a user with respect the user terminal 100 (step S502). Although the processing of step S502, specifically, is a judgment of whether or not a signal indicating that a user has made a bet instruction has been received, in the following description, this description will be omitted. If there has been a bet instruction by a user with respect to the user terminal 100, the separate game control unit 361 subtracts from the virtual money owned by the user and adds to the bet amount (step S504). Next, the separate game control unit 361, in the condition in which at least the minimum bet amount has been placed, judges whether or not a start instruction has been made by the user with respect to the user terminal 100 (step S506).

In the condition in which at least the minimum bet amount has been placed, if there has been a start instruction made to the user terminal 100, the separate game control unit 361 causes the reels of the reel section h (FIG. 7, FIG. 16, and FIG. 17) to rotate for some amount of time and automatically stop (step S508). Then, the separate game control unit 361 makes a payout in accordance the symbols arranged on the effective line or lines, adding to the virtual money owned by the user (step S510).

Next, the separate game control unit 361 judges whether or not the stage has been cleared (step S512). If the stage has been cleared, the separate game control unit 361 enables playing of the next stage (step S514). The separate game control unit 361 judges whether or not the stage has progressed to a reference stage (step S516). If progression has been made to the reference stage, the separate game control unit 361 changes the mode or form of the slot machine game as a separate game (step S518). A plurality of reference stages may exist, in which case the mode or form of the slot machine game may change a plurality of times.

Then, the separate game control unit 361 judges whether or not an end instruction has been given by the user to the user terminal 100 (step S520). If there has not been an end instruction, the separate game control unit 361 returns to step S502, and if there has been an end instruction, the processing of the flowchart of FIG. 31 ends.

The flow of FIG. 32 will now be described. The flow of FIG. 32 is an example of a flowchart showing the flow of the processing executed by the inter-group competition performing unit 380 for the case in which there are two groups executing an inter-group competition. The inter-group competition performing unit 380 obtains the virtual money owned by king (1) and the virtual money owned by king (2) from the first-king owned virtual-money-related information storage unit 331 and the second-king owned virtual money storage unit 341, respectively (step S611). Next, the inter-group competition performing unit 380 judges which king owns more money (step S612). Then, the inter-group competition performing unit 380 controls so that the judgment result is displayed on the user terminal 100, and stores the judgment result in the inter-group competition result storage unit 325 (step S613).

The flow of FIG. 33 will now be described. FIG. 33 is an example of a flowchart showing the flow of processing executed by the inter-group competition performing unit 380 for the case in which three or more groups execute an inter-group competition. The inter-group competition performing unit 380 obtains the virtual money owned by each king from the king-owned virtual-money-related information storage units (331, 341, and so on), respectively (step S614). Next, the inter-group competition performing unit 380 calculates the ranking of the virtual money of the kings (step S615). Then, the inter-group competition performing unit 380 controls to display the ranking of the virtual money owned by the kings on the user terminal 100, and stores the ranking in the inter-group competition result storage unit 325 (step S616).

### [Effects]

According to the game system 1 and the game server (game device) 300 of the present embodiment described above, by making distribution in accordance with the virtual money owned by the kings, a feeling of togetherness is imparted to the users within a group, enabling enhancement of the interest in the game. For example, if the virtual money owned by the king becomes large, by increasing the amount distributed to the users, a large amount of virtual money owned is won in a separate game and the virtual money owned by the king is increased, thereby enabling the imparting to a user of the motivation to increase the distributed amount within the group.

According to the game system 1 and the game server 300 of the present embodiment, because inter-group competition is performed in which a comparison is made between the virtual money owned by kings between groups and the results thereof are displayed on the user terminal 100, it is possible to excite the fighting spirit in a user and instill motivation to play the game.

According to the game system 1 and the game server 300 of the present embodiment, because the method of calculating the amount distributed to users is changed based on a comparison between the virtual money owned by the king of a group and that owned by kings of other groups, it is possible to heat up the competition between groups and enhance the interest in the game. Specifically, if the virtual money owned by a group's king is less than the virtual money owned by the king of another group, the game system 1 and the game server 300 increase the amount distributed to the king of the group, so as to heat up the inter-group competition and enhance interest in the game. Specifically, if the virtual money owned by the king of a group is less than that owned by the kings of other groups, the game system 1 and the game server 300 increase the relative amount distributed with respect to the virtual money owned by the king of the group, thereby heating up the inter-group competition and enhancing interest in the game.

According to the game system 1 and the game server 300 of the present embodiment, because form of the slot machine game is changed in accordance with the progression through stages, it is possible to impart a feeling of freshness to the playing user.

According to the game system 1 and the game server 300 of the present embodiment, by indicating to a user the stage progression of other users within the group, it is possible to impart togetherness to the group and enhance the motivation to play the game.

### [Hardware Implementation]

The user terminal 100, the SNS server 200, and the game server 300 according to the described embodiments have therewithin a computer system. A “computer system” encompasses hardware such as a CPU (central processing unit), a memory device such as RAM or the like, a storage device such as a ROM, a hard-disk drive, or a flash memory, a drive apparatus for a removable storage medium, and peripheral devices and the like.

The processes of the operations of each of the functional parts included in the above-described control unit 150 of the user terminal 100, the SNS control unit 210 of the SNS server 200, and the control unit 350 of the game server 300 are, for example, stored in a computer-readable storage medium in the form of a program, and the above-noted processing can be performed by a computer system reading and executing this program. Also, rather than all of the processing of each function part being performed by performing of the program, a part of the functional parts may be implemented by hardware such as an IC (integrated circuit), and LS1 (large-scale integration) device, or on a network card or the like.

The term “computer readable recording medium” as used herein refers to a removable medium such as a flexible disc, an optical disk, an optomagnetic disk, a ROM, a CD-ROM, or the like, or a storage device such as a hard disk or the like that is built into a computer system. Additionally, the term “computer-readable recording medium” may include one that dynamically holds a program for a given period of time, such as various devices included in a communication system that transmits a program via a network such as the Internet or by a communication circuit such as a telephone line, and also a device that holds a program for a certain time, such as a volatile memory of a computer system that functions as a server or client in that case.

The above-noted program may implement a part of the above-described functions, and further may implement the above-described functions in combination with a program already stored in a computer system.

### [Variations and Others]

Although the foregoing has been a description of aspects for embodying the present invention, using embodiments, the present invention is not at all restricted to such embodiments, and may be subjected to various variations and substitutions within the scope of the spirit of the present invention.

For example, although in the above-noted embodiment the description is for the case in which the user terminal 100 progresses through a game by causing operation of a browser application, with the control of the game being substantially executed by the game server 300, a part of the substantial control of the game may be performed by the user terminal 100. For example, the user terminal 100 may store therewithin an application program for the purpose of a user playing a separate game. In this case, a part of the functional parts of the game server 300 shown by example in FIG. 10 is provided in the user terminal 100.

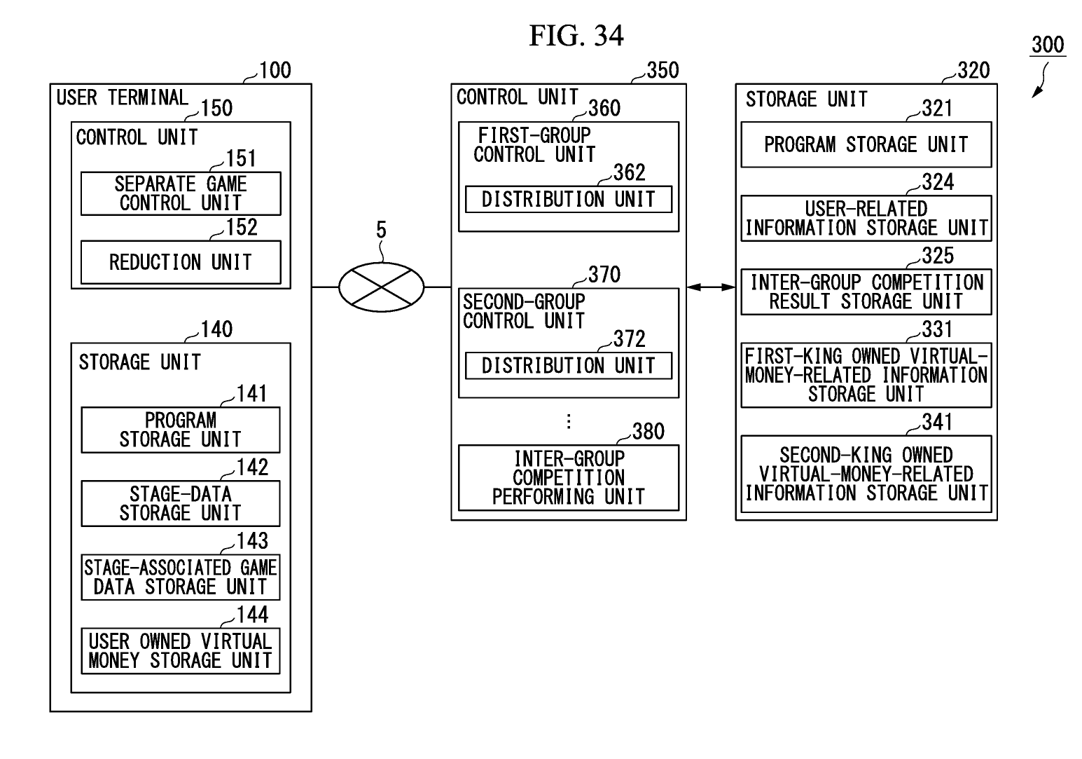

FIG. 34 shows another example of the functional configuration of the game system of the present embodiment. In FIG. 34, the input unit 110, the communication unit 120, the display unit 130, the SNS server 200, and the communication unit 310 and the like have been omitted. In FIG. 34, the control unit 150 of the user terminal 100 may include, for example, but is not limited to, a separate game control unit 151 and a return unit 152. The storage unit 140 of the user terminal 100 may include, for example, but is not limited to, a program storage unit 141, a stage-data storage unit 142, a stage-associated game data storage unit 143, and a user owned virtual money storage unit 144. The separate game control unit 151 performs processing that is the same as the separate game control units (361, 371, and so on) in the above-noted embodiments, and provides a separate game to a user. The return unit 152 performs processing that is the same as the return units (363, 373, and so on) in the above-noted embodiments, and returns at least a part of the virtual money owned by the users to the virtual money owned by the king of the group to which the users belong.

The program storage unit 141 stores various programs that are executed by the control unit 150 (this corresponding to the program storage unit 321 in the above-noted embodiments). The stage-data storage unit 142 stores the hierarchical structure of a plurality of stages (this corresponding to the stage-data storage unit 322 in the above-noted embodiments). The stage-associated game data storage unit 143 stores the stage-specific play and the mode or form of the slot machine game (this corresponding to the stage-associated game data storage unit 323 in the above-noted embodiments). The user owned virtual money storage unit 144 stores information related to the virtual money owned by the user using the user terminal 100 (this corresponding to the user owned virtual-money-related information storage units 332-1 to N, 342-1 to M, and so on in the above-noted embodiments).

In the game server 300, the first-group control unit 360 has a distribution unit 362 and the second-group control unit 370 has a distribution unit 372. The storage unit 320 of the game server 300 may include, for example, but is not limited to, a program storage unit 321, a user-related information storage unit 324, an inter-group competition result storage unit 325, a first-king owned virtual-money-related information storage unit 331, and a second-king owned virtual-money-related information storage unit 341. In this manner, in the case in which the user terminal 100 performs a part of the substantial control of the game, the game server 300 may have only functions and information for performing control as a group.

Although in the above-noted embodiments communication between the user terminal 100 and the game server 300 is performed via the SNS server 200, the user terminal 100 and the game server 300 may communicate directly. Also, user terminals 100 may communicate directly with each other, and communication between the user terminal 100 and the game server 300 may be combined with communication between user terminals 100.

Also, although in the above-noted embodiments the game system 1 takes the form in which a plurality of user terminals 100 or game servers 300 are connected via the network 5, other forms are possible. For example, the game system 1 may be designed based on a game device (which has an interface enabling play by a plurality of users) installed within an amusement facility (game arcade), or may be designed based on a home game device (which has operating devices for each of a plurality of users).

What is claimed is:

1. A game system comprising:
i) a first storage unit configured to store a first information related to a first virtual value that is commonly-associated to a first in-game group of users;
ii) a second storage unit configured to store a second information related to a second virtual value that is individually-ownable and in-game-usable by an individual user of the first in-game group of users;
iii) a first distribution unit configured to increase an individual amount of the second virtual value individually-owned by the individual user of the first in-game group of users, with reference to the amount of the first virtual value;
iv) a first control unit configured to decrease the individual amount of the second virtual value individually-owned by the individual user of the first in-game group of users, in accordance with an in-game use request by the individual user; and
v) a first reduction unit configured to reduce at least a part of the individual amount of the second virtual value, individually-owned by the individual user of the first in-game group of users, and to increase the amount of the first virtual value.

2. The game system according to claim 1, wherein the first control unit is configured to further perform processes of a game that is playable by the individual user of the first in-game group of users, while decreasing the individual amount of the second virtual value individually-owned by the individual user, in accordance with the in-game-use-request by the individual user, and
the first control unit is configured to increase the individual amount of the second virtual value individually-owned by the individual user, with reference to a result of the processes of the game.

3. The game system according to claim 1, wherein the game is playable in sole by an individual user of the first in-game group of users.

4. The game system according to claim 2, wherein the first control unit is configured to make a change in mode of the game if the first control unit verified that a condition for progression of the game is satisfied.

5. The game system according to claim 1, wherein the first distribution unit is configured to distribute at least a part of the amount of the first virtual value to the individual amount of the second virtual value individually-owned by the individual user, in accordance with the amount of the first virtual value.

6. The game system according to claim 2, wherein the first distribution unit is configured to distribute at least a part of the amount of the first virtual value to the individual amount of the second virtual value individually-owned by the individual user, in accordance with the amount of the first virtual value.

7. The game system according to claim 4, wherein the first distribution unit is configured to distribute at least a part of the amount of the first virtual value to the individual amount of the second virtual value individually-owned by the individual user, in accordance with the amount of the first virtual value.

8. The game system according to claim 1, further comprising:
vi) a third storage unit configured to store a third information related to a third virtual value that is commonly-associated to a second in-game group of users;
vii) a fourth storage unit configured to store a fourth information related to a fourth virtual value that is individually-ownable and in-game-usable by an individual user of the second in-game group of users;
viii) a second distribution unit configured to increase an individual amount of the fourth virtual value individually-owned by the individual user of the second in-game group of users, with reference to the amount of the third virtual value;
ix) a second control unit configured to decrease the individual amount of the fourth virtual value individually-owned by the individual user of the second in-game group of users, in accordance with an in-game-use-request by the individual user of the second in-game group of users;
x) a second reduction unit configured to reduce at least a part of the individual amount of the fourth virtual value, individually-owned by the individual user of the second in-game group of users, and to increase the amount of the first virtual value; and
xi) a competition unit configured to perform a competition between the first in-game group of users and the second in-game group of users under a competition rule, with reference to the amount of the first virtual value and the amount of the third virtual value.

9. The game system according to claim 2, further comprising:
vi) a third storage unit configured to store a third information related to a third virtual value that is commonly-associated to a second in-game group of users;
vii) a fourth storage unit configured to store a fourth information related to a fourth virtual value that is individually-ownable and in-game-usable by an individual user of the second in-game group of users;
viii) a second distribution unit configured to increase an individual amount of the fourth virtual value individually-owned by the individual user of the second in-game group of users, with reference to the amount of the third virtual value;
ix) a second control unit configured to decrease the individual amount of the fourth virtual value individually-owned by the individual user of the second in-game group of users, in accordance with an in-game-use-request by the individual user of the second in-game group of users;
x) a second reduction unit configured to reduce at least a part of the individual amount of the fourth virtual value, individually-owned by the individual user of the second in-game group of users, and to increase the amount of the first virtual value; and
xi) a competition unit configured to perform a competition between the first in-game group of users and the second in-game group of users under a competition rule, with reference to the amount of the first virtual value and the amount of the third virtual value.

10. The game system according to claim 3, further comprising:
vi) a third storage unit configured to store a third information related to a third virtual value that is commonly-associated to a second in-game group of users;
vii) a fourth storage unit configured to store a fourth information related to a fourth virtual value that is individually-ownable and in-game-usable by an individual user of the second in-game group of users;
viii) a second distribution unit configured to increase an individual amount of the fourth virtual value individually-owned by the individual user of the second in-game group of users, with reference to the amount of the third virtual value;
ix) a second control unit configured to decrease the individual amount of the fourth virtual value individually-owned by the individual user of the second in-game group of users, in accordance with an in-game-use-request by the individual user of the second in-game group of users;
x) a second reduction unit configured to reduce at least a part of the individual amount of the fourth virtual value, individually-owned by the individual user of the second in-game group of users, and to increase the amount of the first virtual value; and
xi) a competition unit configured to perform a competition between the first in-game group of users and the second in-game group of users under a competition rule, with reference to the amount of the first virtual value and the amount of the third virtual value.

11. The game system according to claim 4, further comprising:
vi) a third storage unit configured to store a third information related to a third virtual value that is commonly-associated to a second in-game group of users;
vii) a fourth storage unit configured to store a fourth information related to a fourth virtual value that is individually-ownable and in-game-usable by an individual user of the second in-game group of users;
viii) a second distribution unit configured to increase an individual amount of the fourth virtual value individually-owned by the individual user of the second in-game group of users, with reference to the amount of the third virtual value;
ix) a second control unit configured to decrease the individual amount of the fourth virtual value individually-owned by the individual user of the second in-game group of users, in accordance with an in-game-use-request by the individual user of the second in-game group of users;
x) a second reduction unit configured to reduce at least a part of the individual amount of the fourth virtual value, individually-owned by the individual user of the second in-game group of users, and to increase the amount of the first virtual value; and
xi) a competition unit configured to perform a competition between the first in-game group of users and the second in-game group of users under a competition rule, with reference to the amount of the first virtual value and the amount of the third virtual value.

12. The game system according to claim 8, wherein the first distribution unit is configured to decide an increasing amount of the individual amount of the second virtual value, with reference to the amount of the first virtual value and the amount of the third virtual value.

13. The game system according to claim 12, wherein the first distribution unit is configured to decide the increasing amount of the individual amount of the second virtual value, depending on a result of comparison made in accordance with a rule of comparison between the amount of the first virtual value and the amount of the third virtual value.

14. The game system according to claim 8, wherein the first distribution unit is configured to decide the frequency of increment in the individual amount of the second virtual value, depending on a result of comparison made in accordance with a rule of comparison between the amount of the first virtual value and the amount of the third virtual value.

15. The game system according to claim 8, wherein the first distribution unit is configured to decide the amount of one-time-increment in the individual amount of the second virtual value, depending on a result of comparison made in accordance with a rule of comparison between the amount of the first virtual value and the amount of the third virtual value.

16. A game system comprising:
i) an inter-group competition unit configured to perform an inter-group competition between a first in-game group of users and a second in-game group of users under a competition rule, with reference to the amount of a first virtual value and the amount of a third virtual value, the amount of the first virtual value being variable depending upon a first totality of individual game-results of individual users of the first in-game group of users, the amount of the third virtual value being variable depending upon a second totality of individual game-results of individual users of the second in-game group of users; and
ii) a distribution unit configured to perform, with reference to a result of the inter-group competition performed by the inter-group competition unit, at least one of a first way of virtual-value-distribution to virtual value amounts individually-owned by individual users of the first in-game group of users, and a second way of virtual-value-distribution to virtual value amounts individually-owned by individual users of the second in-game group of users.

17. A game device comprising:
i) a first distribution unit configured to increase an individual amount of a first virtual value that is individually-owned and in-game-usable by an individual user of a first in-game group of users, with reference to the amount of a second virtual value that is commonly-associated to the first in-game group of users;
ii) a first control unit configured to decrease the individual amount of the first virtual value, in accordance with an in-game-use-request by the individual user; and
iii) a first reduction unit configured to reduce at least a part of the individual amount of the first virtual value to increase the amount of the second virtual value.

18. A gaming method comprising:
i) increasing, by a computer, an individual amount of a first virtual value that is individually-owned and in-game-usable by an individual user of a first in-game group of users, with reference to the amount of a second virtual value that is commonly-associated to the first in-game group of users;
ii) decreasing, by the computer, the individual amount of the first virtual value, in accordance with an in-game-use-request by the individual user; and
iii) reducing, by the computer, at least a part of the individual amount of the first virtual value to increase the amount of the second virtual value.

19. A gaming method comprising:
i) performing, by a computer, an inter-group competition between a first in-game group of users and a second in-game group of users under a competition rule, with reference to the amount of a first virtual value and the amount of a second virtual value, the amount of the first virtual value being variable depending upon a first totality of individual game-results of individual users of the first in-game group of users, the amount of the second virtual value being variable depending upon a second totality of individual game-results of individual users of the second in-game group of users; and
ii) performing, by the computer, with reference to a result of the inter-group competition, at least one of a first way of virtual-value-distribution to virtual value amounts individually-owned by individual users of the first in-game group of users, and a second way of virtual-value-distribution to virtual value amounts individually-owned by individual users of the second in-game group of users.

20. A computer program product embodied on a non-transitory computer readable medium, the computer program product comprising:
i) instructions to increase an individual amount of a first virtual value that is individually-owned and in-game-usable by an individual user of a first in-game group of users, with reference to the amount of a second virtual value that is commonly-associated to the first in-game group of users;
ii) instructions to decrease the individual amount of the first virtual value, in accordance with an in-game-use-request by the individual user; and
iii) instructions to reduce at least a part of the individual amount of the first virtual value to increase the amount of the second virtual value.

21. A computer program product embodied on a non-transitory computer readable medium, the computer program product comprising:
i) instructions to perform an inter-group competition between a first in-game group of users and a second in-game group of users under a competition rule, with reference to the amount of a first virtual value and the amount of a second virtual value, the amount of the first virtual value being variable depending upon a first totality of individual game-results of individual users of the first in-game group of users, the amount of the second virtual value being variable depending upon a second totality of individual game-results of individual users of the second in-game group of users; and
ii) instructions to perform, with reference to a result of the inter-group competition, at least one of a first way of virtual-value-distribution to virtual value amounts individually-owned by individual users of the first in-game group of users, and a second way of virtual-value-distribution to virtual value amounts individually-owned by individual users of the second in-game group of users.
